(19) United States
(12) Patent Application Publication
(10) Pub. No.: US 2026/0138902 A1
(43) Pub. Date: May 21, 2026

(54) WASTEWATER TREATMENT SYSTEMS AND METHODS INVOLVING A BIOLOGICALLY ACTIVE CONDUIT

(71) Applicant: Christopher R. OTT, Napa, CA (US)

(72) Inventor: Christopher R. OTT, Napa, CA (US)

(21) Appl. No.: 19/483,988

(22) PCT Filed: Jul. 17, 2025
(86) PCT No.: PCT/US2025/037997

§ 371 Date: Nov. 13, 2025

Related U.S. Application Data
(60) Provisional application No. 63/672,713, filed on Jul. 18, 2024.

(51) Int. Cl. C02F 3/30; C02F 3/12; C02F 101/36

(52) U.S. Cl. CPC C02F 3/30; C02F 3/1294; C02F 2101/36; C02F 2201/005; C02F 2201/007; C02F 2203/006; C02F 2301/02; C02F 2301/046; C02F 2303/04

(57) ABSTRACT

Described are wastewater treatment systems comprising a biologically active conduit defining a single, confined serpentine flow path twisting from top to bottom portions. The system establishes sequential aerobic, anoxic, and anaerobic treatment zones populated with zone-specific biological chips containing dominant biologically active media. Mesh separators prevent biological chip displacement between zones while allowing wastewater flow. The system receives influent wastewater through a bottom opening and dispenses treated effluent from the same opening following simultaneous batch treatment across all zones. Methods include wastewater treatment processes, modular assembly techniques, and attribute management systems using adjustable bypass valves and venturi-based air introduction for precise dissolved oxygen control. The systems achieve enhanced PFAS removal by reducing organic matter competition for granular activated carbon (GAC) adsorption sites, extending GAC operational life by at least 25%. Advanced features include dual recirculation capabilities, overflow protection, space-efficient modular design, and fine-tuned control enabling >90% PFAS removal efficiency.

### RELATED CASE

This application claims priority to provisional application No. 63/672,713, filed on Jul. 18, 2024, which is incorporated herein by reference for all purposes.

### FIELD

The present disclosure relates to wastewater treatment systems and methods for biological treatment of wastewater using modular, space-efficient designs. More particularly, the present disclosure relates to wastewater treatment systems comprising biologically active conduits with serpentine flow paths that establish sequential aerobic, anoxic, and anaerobic treatment zones, each populated with zone-specific biological media for comprehensive wastewater treatment including removal of organic compounds, nutrients, and per- and polyfluoroalkyl substances (PFAS).

### BACKGROUND

Conventional wastewater treatment systems require capital intensive equipment to implement anaerobic and/or aerobic digestion and other treatment techniques. As a result, wastewater treatment is not always seen as a commercially viable solution particularly when relatively low to moderate volumes of wastewater is to be treated for avoiding critical contamination issues.

What are, therefore, needed are novel systems and methods that render wastewater treatment commercially viable at even low to moderate volumes of wastewater.

### SUMMARY

To achieve the foregoing, the present arrangements offer systems and methods relating to wastewater treatment that are commercially viable at even low to moderate volumes of water.

### Wastewater Treatment System

In one aspect, the present arrangements and teachings provide wastewater treatment systems. One exemplar of such wastewater treatment systems comprises a biologically active conduit defining a single, confined serpentine flow path twisting from a top portion, through a middle portion, to a bottom portion. The bottom portion is populated with anaerobic dominant biologically active media to effectively create an anaerobic treatment zone, the middle portion is populated with anoxic dominant biologically active media to effectively create an anoxic treatment zone, and the top portion is populated with aerobic dominant biologically active media to effectively create an aerobic treatment zone.

The bottom portion has defined therein a bottom opening configured to receive influent wastewater, and following batch treatment simultaneously within the aerobic, anoxic, and anaerobic treatment zones of the single, confined serpentine flow path, dispenses treated wastewater. The exemplar wastewater treatment system includes an aerobic/anoxic treatment zone separator, and an anoxic/anaerobic treatment zone separator disposed inside the biologically active conduit to serve as physical boundaries between the respective treatment zones.

Aerobic biological chips containing aerobic dominant biologically active media are disposed inside the aerobic treatment zone, anoxic biological chips containing anoxic dominant biologically active media are disposed inside the anoxic treatment zone, and anaerobic biological chips containing anaerobic dominant biologically active media are disposed inside the anaerobic treatment zone. The separators prevent displacement of the biological chips between treatment zones. Described below are alternate embodiments that implement optional structural components and features that may be advantageous when practicing the present arrangements and teachings.

### Modular Configuration and System Components

The wastewater treatments systems, according to the present arrangements, may further comprise a plurality of biologically active conduits each having confined serpentine flow paths terminating at bottom openings. In this configuration, the plurality of biologically active conduits extends parallelly with respect to each other and are supported on a rack forming a biologically treatment module (hereinafter “module”).

In preferred embodiments, the module of the present arrangements has a width ranging from about 7 feet to about 20 feet, a length ranging from about 5 feet to about 40 feet and a height ranging from about 8 feet to about 13 feet, and the biologically active conduit has a diameter ranging from about 6 feet to about 12 feet.

Each of the aerobic/anoxic treatment zone separator and the anoxic/anaerobic treatment zone separator is composed of a mesh, which has defined therein openings that prevent relatively larger aerobic biological chips, anoxic biological chips, and anaerobic biological chips from passing through and allow the wastewater and treated wastewater to pass through.

### Recirculation and Flow Control Systems

The present wastewater treatment systems, preferably, include a recirculation subassembly including a recirculation inlet line designed to facilitate fluid communication of treated wastewater from the bottom openings of the plurality of biologically active conduits to top inlets disposed at the top portion of the plurality of biologically active conduits. In this preferred embodiment, the present wastewater treatment systems also include one or more venturis disposed at or near a top portion of the plurality of biologically active conduits. One or more venturis, in these arrangements, are designed to receive treated wastewater from the recirculation inlet line and introduce air into the treated wastewater prior to the treated wastewater entering the top portion of the plurality of biologically active conduits. One or more recirculation manifolds are disposed at or near a top portion of the plurality of biologically active conduits and downstream from one or more of the venturis. They are designed to be in fluid communication with the recirculation inlet line, and each of the recirculation manifolds has a plurality of recirculation manifold outlets designed to convey treated wastewater, received from the recirculating line, to the plurality of top inlets of the plurality of biologically active conduits.

Each venturi is designed to draw air or oxygen to facilitate at least one type of aerobic treatment chosen from a group comprising digesting organic material present in wastewater, reducing chemical oxygen demand (“COD”), reducing biochemical oxygen demand (“BOD”), reducing ammonia to produce nitrite compounds, and reducing nitrite compounds to produce nitrate compounds.

An influent line, following batch treatment simultaneously within the aerobic, anoxic, and anaerobic treatment zones, provides treated wastewater to the recirculation inlet line. This is, preferably, the same influent line that provides influent wastewater to the plurality of biologically active conduits.

### Influent Management and Flow Control

The present wastewater treatment systems may further comprise an influent subassembly. This influent subassembly includes an influent line designed for receiving wastewater from an equalization tank. The equalization tank, in turn, has stored therein wastewater for treatment. In this embodiment, the present wastewater treatment systems further include one or more influent manifolds disposed at or near the bottom portion of the plurality of biologically active conduits and that are designed to be in fluid communication with the influent line. Each of the influent manifolds has a plurality of influent manifold outlets designed to convey wastewater, received from the influent line to the plurality of bottom openings of the plurality of biologically active conduits.

The influent subassembly of the present arrangements, preferably, further comprises: (i) a first isolation ball valve designed to stop flow of influent wastewater; (ii) an influent automatic valve designed to automatically regulate flow of the influent wastewater; (iii) a second isolation ball valve designed to stop flow of the influent wastewater after the influent automatic valve; (iv) an influent grit solid screen designed to filter out solids present in the influent wastewater; and (v) a third isolation ball valve designed to stop flow of the influent wastewater after the influent grit solid screen and into the biologically active conduit. In this configuration, the first isolation ball valve and the second isolation ball valve are positioned to allow isolation of the influent automatic valve, and the second isolation ball valve and the third isolation ball valve are positioned to allow isolation of the influent grit solid screen for maintenance purposes.

### Overflow Protection and Environmental Controls

The present wastewater treatment systems may further comprise an overflow subassembly. The overflow subassembly includes one or more overflow manifolds disposed at or near the top portion of the plurality of biologically active conduits. Each overflow manifold includes a plurality of overflow manifold outlets designed to receive, through a plurality of top outlets of the plurality of biologically active conduits, excessive wastewater present inside the plurality of biologically active conduits.

The overflow subassembly also includes an overflow line designed for collecting the excessive wastewater from the plurality of top outlets and dispensing the excessive wastewater to an equalization tank. In this embodiment, the wastewater treatment systems further comprise an air/gas release passage, disposed at or near the anoxic treatment zone, for releasing air or gas collected inside the anoxic treatment zone to maintain an effective anoxic environment inside the anoxic treatment zone by reducing nitrate compound to nitrogen gas. As a result, the oxygen content in the anoxic environment is effectively maintained to be less than in the aerobic treatment zone.

### Multi-Module Treatment Systems

The present wastewater treatment systems may comprise a first set of biologically active conduits forming a first module and a second set of biologically active conduits forming a second module.

A first module effluent conduit is in fluid communication with the first module and designed to convey treated wastewater from the first module to the second module or a recirculation inlet line, which recirculates treated wastewater back to the first module. A first module recirculation valve is disposed on the recirculation inlet line and, in an open position, allows treated wastewater to flow from the first module, through the first module effluent conduit and the recirculation inlet line, back to the first module.

A first module post-treatment conduit is in fluid communication with the second module, and a first automatic valve is disposed on the first module post-treatment conduit and, in an open position, allows treated wastewater to advance from the first module to the second module.

A discharge pump is disposed at the intersection of the first module effluent conduit and the first module post-treatment conduit, such that in an open position of the first module recirculation valve and a closed position of the first automatic valve of the first module, treated water flows back to the first module, and in an open position of the first automatic valve and a closed position of the first module recirculation valve, treated water flows to the second module.

### Second Module Configuration and Post-Treatment Integration

The wastewater treatment systems of the present arrangements further comprise a second module effluent conduit in fluid communication with the second module and that is designed to convey treated wastewater from the second module to a post-biological-treatment disc filter or a recirculation inlet line, which recirculates treated wastewater back to the second module.

A second module recirculation valve is disposed on the recirculation inlet line and, in an open position, allows treated wastewater to flow from the second module, the second module effluent conduit and the second module recirculation inlet line, back to the second module.

A second module post-treatment conduit is in fluid communication with the second module, and a second automatic valve is disposed on the second module post-treatment conduit and, in an open position, allows treated wastewater to advance from the second module to a disc filter.

A discharge pump is disposed at the intersection of the first module effluent conduit and the first module post-treatment conduit, such that in an open position of the second module recirculation valve and a closed position of the second automatic valve, treated water flows back to the second module, and in an open position of the second automatic valve and a closed position of the second module recirculation valve, treated water flows to the disc filter subassembly.

The second module is disposed downstream from the first module. Furthermore, each of the first and the second modules comprises: (i) a plurality of parallelly extending biologically active conduits; (ii) one or more of the aerobic/anoxic treatment zone separators, (iii) one or more of the anoxic/anaerobic treatment zone separators, and (iv) aerobic biological chips, anoxic biological chips, and anaerobic biological chips.

The first module is designed to carry out a first type of wastewater treatment and the second module is designed to carry out a second type of wastewater treatment, which is different from the first type of wastewater treatment. In one embodiment of the present teachings, during an operational state of the present wastewater treatment systems, the first module removes organic compounds from wastewater present inside the first module and the second module removes nutrients from wastewater present inside the second module.

### Automated Control and Monitoring Systems

The waste treatment systems of the present arrangements may comprise: (i) one or more biologically active conduits; (ii) a solids-separator subsystem disposed upstream from one or more of the biologically active conduits; (iii) an equalization tank disposed downstream from the solids-separator subsystem; (iv) a level sensor designed to detect wastewater level present inside the equalization tank; and (v) a pump communicatively coupled to the level sensor such that when the level sensor, in an operative state, detects a predetermined wastewater level value inside the equalization tank, the level sensor conveys a signal that is received by the pump to pump wastewater from the equalization tank to one or more of the biologically active conduits. In this optional arrangement of the present teachings, the solids-separator subsystem is designed to separate solids from the wastewater and the equalization tank is designed to hold wastewater received from the solids-separator subsystem.

The waste treatment systems of the present arrangements may further comprise a domestic wastewater line designed to deliver wastewater from a domestic source to a septic tank, which serves as the solids-separator subsystem, and/or a commercial/industrial wastewater line designed to deliver wastewater from a commercial/industrial source to the solids-separator subsystem.

### Advanced Treatment and Disinfection Systems

The waste treatment systems of the present arrangements, preferably, further comprise a disc filter subassembly disposed downstream from the anaerobic treatment zone of the biologically active conduit. The disc filter subassembly is designed to filter out suspended solids from wastewater present inside the disc filter subassembly and produce substantially suspended-solids-free wastewater.

In one implementation of this configuration, a carbon treating subassembly is disposed downstream from the disc filter subassembly and designed to polish using a carbon source the substantially suspended-solids-free wastewater and produce carbon-treated wastewater. The carbon treating subassembly is designed to remove any one compound chosen from a group comprising per- and polyfluoroalkyl substances (“PFAS”), organic and inorganic compounds from wastewater present inside the carbon treating subassembly to produce carbon-treated wastewater.

An ultraviolet treatment subsystem, is preferably, disposed downstream from the carbon treating subassembly. The ultraviolet treatment subsystem is designed to treat the carbon-treated wastewater with light in UV spectrum. A disinfecting subsystem may be disposed downstream from the anaerobic treatment zone of the biologically active conduit for treating wastewater present inside the disinfecting subsystem with a disinfectant.

### Methods of Wastewater Treatment

In another aspect, the present teachings provide methods for wastewater treatment. One exemplar of such methods comprises a receiving element that includes—receiving wastewater into a bottom opening disposed at a bottom portion of a biologically active conduit defining a single, confined serpentine flow path twisting from a top portion, through a middle portion, to a bottom portion. By way of example, receiving element of the present wastewater treatment methods includes receiving wastewater accumulated inside an equalization tank.

The present methods for wastewater treatment also includes an aerobically treating element. This element requires aerobically treating wastewater, present inside an aerobic treatment zone disposed at or near the top portion of the biologically active conduit, with aerobic dominant biologically active media to effectively create aerobically treated wastewater. Furthermore, aerobically treating the wastewater requires drawing air into the aerobic treatment zone using a venturi disposed at or near the top portion of the biologically active conduit.

The present methods of wastewater treatment further include anoxically treating wastewater, present inside an anoxic treatment zone disposed at or near the middle portion of the biologically active conduit, with anoxic dominant biologically active media to effectively create anoxically treated wastewater.

Further still, the present methods of wastewater treatment require anaerobically treating wastewater, present inside an anaerobic treatment zone disposed at or near the bottom portion of the biologically active conduit, with dominant anaerobic biologically active media to effectively create effluent treated wastewater.

The present methods of wastewater treatment may conclude with dispensing effluent treated wastewater from the bottom opening at the bottom portion of the biologically active conduit. Described below are alternate embodiments that implement optional method elements that may be advantageous when practicing the present teachings.

### Biological Treatment Process Enhancement

Aerobically treating element of the present methods is, preferably, carried out in the presence of aerobic biological chips containing aerobic dominant biologically active media. The aerobic biological chips are disposed inside one or more linear portions that form the aerobic treatment zone.

According to the present methods of wastewater treatment, the anoxically treating requirement is, similarly preferably, carried out in presence of anoxic biological chips containing anoxic dominant biologically active media. The anoxic biological chips are disposed inside one or more linear portions that form the anoxic treatment zone.

The anaerobically treating requirement of the present methods of wastewater treatment is carried out in presence of anaerobic biological chips containing anaerobic dominant biologically active media. The anaerobic biological chips are disposed inside one or more linear portions that form the anaerobic treatment zone.

In those instances where appropriate types of biological chips are deployed, the present wastewater treatment methods comprise a first preventing element that—prevents displacement of aerobic biological chips from the aerobic treatment zone into the anoxic treatment zone using an aerobic/anoxic treatment zone separator, which is disposed inside the biologically active conduit. The aerobic/anoxic treatment zone separator serves as a physical boundary between the aerobic treatment zone and the anoxic treatment zone during aerobic treating and anoxic treating.

Similarly, the present wastewater treatment methods may further comprise a second preventing element that—prevents displacement of anoxic biological chips from the anoxic treatment zone into the anaerobic treatment zone using an anoxic/anaerobic treatment zone separator, which is disposed inside the biologically active conduit. The anoxic/anaerobic treatment zone separator serves as a physical boundary between the anoxic treatment zone and the anaerobic treatment zone during anoxic treating and anaerobic treating.

### Wastewater Preprocessing and Feed Control

Receiving element of the present methods of wastewater treatment, preferably, comprises a separating element. In this element, separation of solids from wastewater is carried out. Separating element includes using a solids-separator subsystem disposed upstream from the biologically active conduit to produce solids-depleted wastewater.

The present methods of wastewater treatment may also include an equalizing element, which requires equalizing the solids-depleted wastewater inside an equalization tank disposed downstream from the solids-separator subsystem.

Further, the present methods of wastewater treatment may also include-detecting wastewater level present inside the equalization tank using a level sensor, and pumping the solids depleted wastewater held inside the equalization tank to the bottom opening of the biologically active conduit. In one embodiment of the present teachings, pumping of the solids is carried out by using a pump communicatively coupled to the level sensor. In this arrangement, when the level sensor detects a predetermined wastewater level value inside the equalization tank, the level sensor conveys an activating signal to the pump.

The present methods of wastewater treatment may further comprise-receiving, inside the solid separator subsystem, wastewater including solids from a domestic source using a domestic wastewater line and/or from a commercial/industrial source using a commercial/industrial wastewater line.

### Treatment Process Optimization and Environmental/pollution Control

According to preferred embodiments, the aerobically treating wastewater of the present methods carries out at least one type of aerobic treatment chosen from a group comprising digesting organic material present in wastewater, reducing chemical oxygen demand (“COD”), reducing biochemical oxygen demand (“BOD”), reducing ammonia to produce nitrite compounds, and reducing nitrite compounds to produce nitrate compounds.

The anoxically treating requirement of the present methods includes-releasing to an ambient environment air or gas collected inside the anoxic treatment zone. This releasing requirement may be accomplished by using an air/gas release passage extending from a location at or near the anoxic treatment zone to an exhaust outlet at or near the top portion of the biologically active conduit. As a result, the anoxically treating of the present methods effectively maintains an anoxic environment inside the anoxic treatment zone by reducing nitrate compound to nitrogen gas, as the oxygen content in the anoxic environment is less than in the aerobic treatment zone.

The aerobic treating, anoxic treating and anaerobic treating is, preferably, carried out simultaneously. The present methods of wastewater treatment may further comprise recirculating, using a recirculation inlet line, effluent treated water from the bottom opening to a top inlet disposed at a top portion of the biologically active conduit.

### Overflow of Excess Wastewater

The present methods of wastewater treatment, preferably, further comprise removing excess wastewater present inside the biologically active conduit using, for example, an overflow subassembly which conveys excess wastewater to an equalization tank for storage.

In one embodiment of the present arrangements, one or more overflow manifolds are disposed at or near the top portion of plurality of the biologically active conduits. Each of the overflow manifolds include a plurality of overflow manifold outlets, which are designed to receive, through a plurality of top outlets of the plurality of the biologically active conduits, excessive wastewater presents inside one or more of the biologically active conduits. An overflow line designed for collecting the excessive wastewater from plurality of the top outlets and dispensing the excessive wastewater to the equalization tank.

### Advanced Filtration and Treatment Methods

The present methods of wastewater treatment may further comprise filtering suspended solids from wastewater present inside the disc filter subassembly and producing substantially suspended-solids-free wastewater. One way of accomplishing such filtering includes using a disc filter subassembly disposed downstream from the anaerobic treatment zone of the biologically active conduit.

The present methods of wastewater treatment may also include polishing or carbon treating the substantially suspended-solids-free wastewater for removing at least one compound chosen from a group comprising per- and polyfluoroalkyl substances (“PFAS”), organic and inorganic compounds from wastewater present inside the carbon treating subassembly and producing carbon-treated wastewater. By way of example, a carbon treating subassembly disposed downstream from the disc filter subassembly is used to accomplish this.

According to preferred embodiments of the present teachings, the present methods of wastewater treatment include ultraviolet treating the carbon-treated wastewater with light in UV spectrum. This may be achieved using an ultraviolet treatment subsystem disposed downstream from the carbon treating subassembly. In these preferred embodiments, present methods of wastewater treatment may implement a disinfecting requirement for treating wastewater present inside the disinfecting subsystem with a disinfectant. The present teachings offer a disinfecting subsystem disposed downstream from the anaerobic treatment zone of the biologically active conduit to meet this requirement.

### Module Assembly Methods

In yet another aspect, the present teachings provide methods for assembling a biological treatment module (“module”). One exemplar of such methods comprises obtaining multiple pipe sections, each having a linear portion and/or a twisted portion. An assembled state of such multiple pipe sections defines a serpentine flow path for wastewater.

The present methods for assembling the module include disposing biological chips inside the linear portion of at least some of the pipe sections to form a first zone of a biologically active conduit. The present methods for assembling the module include further include placing a mesh at locations of ingress and egress of the linear portion filled with the biological chips to prevent the biological chips from displacing through the locations of ingress and egress of the linear portion that form the first zone. In this configuration, the twisted portion of at least some of the pipe sections, that form the first zone, are substantially free of biological chips.

The present methods for assembling the module also include disposing biological chips inside the linear portion of at least some of the pipe sections to form a second zone of a biologically active conduit. Similarly, the present methods for assembling the module include placing a mesh at locations of ingress and egress of the linear portion filled with the biological chips to prevent the biological chips from displacing through the locations of ingress and egress of the linear portion that form the second zone of the biologically active conduit. In this configuration, the twisted portion of at least some of the pipe sections, that form the second zone of the biologically active conduit, are substantially free of biological chips.

The present methods for assembling the module further include disposing biological chips inside the linear portion of at least some of the pipe sections to form a third zone of a biologically active conduit. In connection with this zone, the present methods of wastewater treatment include placing a mesh at locations of ingress and egress of the linear portion filled with the biological chips to prevent the biological chips from displacing through the locations of ingress and egress of the linear portion that form the third zone of the biologically active conduit. In this configuration, the twisted portion of at least some of the pipe sections and that form the third zone of the biologically active conduit, are substantially free of biological chips.

The present methods for assembling the module then include connecting one end of the third zone to one end of the second zone and connecting another end of the second zone to the one end of the first zone to form a single biologically active conduit defining a single, confined serpentine flow path twisting from a top portion, through a middle portion to a bottom portion. Although not necessary, the first zone may be the aerobic treatment zone, the second zone may be the anoxic zone, and the third zone may be the anaerobic zone. Described below are alternate embodiments that implement optional method elements that may be advantageous when practicing the present teachings.

### Module Configuration and Integration

The present methods for assembling the module may further comprise forming a plurality of biologically active conduits, each defining a single, confined serpentine flow path twisting from a top portion, through a middle portion to a bottom portion, and then securing the plurality of biologically active conduits on a rack such that the plurality of biologically active conduits extend parallelly and form a module.

The present methods for assembling the module optionally include connecting a plurality of outlets of a recirculation manifold, which is part of a recirculation assembly, to a plurality of biologically active conduits such that the plurality of biologically active conduits collectively process treated wastewater.

The present methods for assembling the module, preferably, further comprise connecting, at one end, a plurality of outlets of an influent manifold to a plurality of bottom openings disposed at a bottom portion of the biologically active conduits, and connecting at another end, the influent manifold to an influent line. In this preferred arrangement, the plurality of biologically active conduits collectively receive wastewater from the influent line. Furthermore, the influent line, preferably, has defined therein a post treatment outlet that allows effluent treated wastewater to be recirculated back to the plurality of biologically active conduits or advanced for further biological treatment.

The present methods for assembling the module may include connecting the post treatment outlet to a post treatment conduit, which is part of a post treatment subassembly and may also include forming a fluid communication between the post treatment conduit, which is part of a post treatment subassembly, and the recirculation subassembly.

### Air Management System for Treatment Attribute Control

In yet another aspect, the present arrangements and teachings provide systems for managing an attribute of wastewater treatment. One exemplar of such systems comprises: (i) a recirculation inlet line designed to deliver treated wastewater; (ii) a manifold line in fluid communication with the recirculation inlet line and designed to dispense treated wastewater received from the recirculation inlet line; (iii) a venturi line connected at a venturi inlet end to the inlet line and connected at a venturi outlet end to the manifold line; and (iv) a bypass line connected at a bypass inlet end to the inlet line and connected at a bypass outlet end to the manifold line. In this configuration, the bypass inlet end and the bypass outlet end are separated a separating distance from the venturi inlet end and the venturi outlet, respectively, such that the bypass line represents a bypass flow path to the venturi line.

The present systems for managing the attribute of wastewater treatment also include: (v) a venturi disposed on the venturi line; and (vi) an adjustable bypass valve disposed on the bypass line. The venturi is designed to draw in and advance air towards the venturi outlet and the manifold line and the adjustable bypass valve is capable of acquiring different settings and thereby capable of regulating flow, through the bypass line, of treated wastewater that enters the manifold line and/or regulating flow, through the venturi and the venturi line, of treated wastewater mixed with air that enters the manifold line.

The present systems for managing the attribute of wastewater treatment further include a manifold coupled to the manifold line. The manifold is capable of receiving and dispersing treated wastewater and air received from the manifold line. Furthermore, there are a plurality of extending outlets protruding from the manifold. These plurality of extending outlets are capable of dispensing treated wastewater and/or air present inside the manifold.

The present systems for managing the attribute of wastewater treatment further include a plurality of biologically active conduits, each of which connect to one of the extending outlets of the manifold. Depending on different settings of the adjustable bypass valve, different amounts of treated wastewater and/or air are mixed and introduced from the extending outlets inside each of the biologically active conduits forming therein different attribute values of wastewater treatment. The attribute of wastewater treatment is one member chosen from a group comprising average lineal feet of the plurality of biologically active conduits that form an aerobic zone, average lineal feet of the plurality of biologically active conduits that form an anoxic zone, average lineal feet of the plurality of biologically active conduits that form an anaerobic zone, average volume of the plurality of biologically active conduits that form the aerobic zone, average volume of the plurality of biologically active conduits that form the anoxic zone, average volume of the plurality of biologically active conduits that form the anaerobic zone, dissolved oxygen concentration profile inside each of the biologically active conduits, average dissolved oxygen concentration profile inside the plurality of biologically active conduits and pressure differential across the venturi.

Described below are alternate embodiments that implement optional structural components and features that may be advantageous when practicing the present teachings.

### Multi-Line Recirculation of Treated Wastewater

The present systems for managing attribute of wastewater treatment may further comprise a recirculation inlet line that splits into multiple recirculation inlet lines, each of which operates in conjunction with a respective one of the manifold line, respective one of the bypass line, respective one of the bypass valve, respective one of the venturi line, respective one of the venturi, respective one of the manifold and respective one of the set of plurality of extending outlets connecting to a set of biologically active conduits that form part of a biological treatment module. In this configuration, multiple sets of biologically active conduits form the plurality of biologically active conduits. Furthermore, the recirculation inlet line carrying treated wastewater from a bottom opening of the biological treatment module is recirculated back to a top portion of the plurality of biologically active conduits of the biological treatment module. Such recirculation is, preferably, accomplished using the multiple recirculation inlet lines, multiple of the manifold lines, multiple of the bypass lines, multiple of the bypass valves, multiple of the venturi lines, multiple of the venturis, multiple of the manifolds and multiple of the set of plurality of extending outlets. The present systems for managing attribute of wastewater treatment may further comprise a t-section that splits the recirculation inlet line into two of the recirculation inlet lines so that such multiplicity of components in the recirculation subassembly is realized.

### Dual-path Air/Treated Wastewater Management Configuration

In certain embodiments, the present systems for managing attribute of wastewater treatment further comprise: (i) a first recirculation inlet line disposed downstream from the t-section and that is designed to receive wastewater, through the t-section, from the recirculation inlet line, (ii) a first manifold line in fluid communication with the first recirculation inlet line and that is designed to dispense wastewater received from the first recirculation inlet line; (iii) a first venturi line connected at a first venturi inlet end to the first recirculation inlet line and connected at a first venturi outlet end to the first manifold line; (iv) a first bypass line connected at a first bypass inlet end to the first recirculation inlet and connected at a first bypass outlet end to the first manifold line.

According to certain embodiments of the present arrangements, the first bypass inlet end and the first bypass outlet end are separated a first separating distance from the first venturi inlet end and the first venturi outlet, respectively. The first bypass line represents a first bypass flow path to the first venturi line.

In these embodiments, the present systems for managing attribute of wastewater treatment further comprise: (v) a first venturi is disposed on the first venturi line and designed to draw in and advance air towards the first venturi outlet and the first manifold line; (vi) a first adjustable bypass valve is disposed on the first bypass line and capable of acquiring different settings. As a result, the first adjustable bypass valve capable of regulating flow, through the first bypass line of treated wastewater that enters the first manifold line and/or regulating flow, through the first venturi and the first venturi line of treated wastewater mixed with air that enters the first manifold line.

The present systems for managing attribute of wastewater treatment further comprise: (vii) a first manifold coupled to the first manifold line and capable of receiving and dispersing treated wastewater and/or air received from the first manifold line; (viii) a first set of plurality of extending outlets protruding from the first manifold and capable of dispensing treated wastewater and/or air dispersed inside the first manifold; (ix) a first set of plurality of conduits, each of which connects to one of the first extending outlets such that depending on different settings of the first adjustable bypass valve, different amounts of treated wastewater and/or air are dispensed from the first extending outlets towards and inside each of the first set of plurality of conduits carrying out wastewater treatment under different values of a first attribute.

Similarly, a second recirculation inlet line is disposed downstream from the t-section and designed to receive wastewater, through the t-section, from the recirculation inlet line. In this arrangement, a second manifold line is in fluid communication with the second recirculation inlet line. In these arrangements of the present systems for managing attribute of wastewater treatment, the second recirculation inlet line is designed to dispense wastewater received from the second recirculation inlet line. Accordingly, a second venturi line is connected at a second venturi inlet end to the second recirculation inlet line and connected at a second venturi outlet end to the second manifold line. Furthermore, a second bypass line is connected at a second bypass inlet end to the second recirculation inlet and connected at a second bypass outlet end to the second manifold line. As a result, the present systems for managing attribute of wastewater treatment further comprise: (x) a second recirculation inlet line; (xi) a second manifold line; (xii) a second venturi line; and (xiii) a second bypass line.

According to certain embodiments of the present arrangements, the second bypass inlet end and the second bypass outlet end are separated a second separating distance from the second venturi inlet end and the second venturi outlet, respectively. The second bypass line represents a second bypass flow path to the second venturi line.

A second venturi is disposed on the second venturi line and designed to draw in and advance air towards the second venturi outlet and the second manifold line. A second adjustable bypass valve is disposed on the second bypass line and capable of acquiring different settings. As a result, the second adjustable bypass valve is capable of regulating flow, through the second bypass line of treated wastewater that enters the second manifold line and/or regulating flow, through the second venturi and the second venturi line of treated wastewater mixed with air that enters the second manifold line.

A second manifold is coupled to the second manifold line and capable of receiving and dispersing treated wastewater and/or air received from the second manifold line. A second set of plurality of extending outlets protrude from the second manifold and are capable of dispensing treated wastewater and/or air dispersed inside the second manifold. A second set of plurality of conduits, each of which connect to one of the second extending outlets such that depending on different settings of the second adjustable bypass valve, different amounts of treated wastewater and/or air are dispensed from the second extending outlets towards and inside each of the second set of plurality of conduits carrying out wastewater treatment under different values of a second attribute. As a result, the present systems for managing attribute of wastewater treatment further comprise: (x) a second venturi; (xi) a second manifold; (xii) a second set of plurality of extending outlets; and (xiii) a second set of plurality of conduits.

The first attribute and the second attribute are at least one attribute chosen from a group comprising average lineal feet of the first set or the second set of biologically active conduits that form the aerobic zone, average lineal feet of the first set or the second set of biologically active conduits that form the anoxic zone, average lineal feet of the first set or the second set of biologically active conduits that form the anaerobic zone, average volume of the first set or the second set of biologically active conduits that form the aerobic zone, average volume of the first set or the second set of biologically active conduits that form the anoxic zone, average volume of the first set or the second set of biologically active conduits that form the anaerobic zone, average dissolved oxygen concentration profile inside the first set or the second set of biologically active conduits, and the pressure differential across the venturi.

### Discharge Pump Integration and Control Mechanisms

The systems for managing attribute of wastewater treatment may further comprise a discharge pump designed for recirculating treated wastewater from the module, through the multiple recirculation inlet lines, multiple manifold lines, multiple bypass lines, multiple bypass valves, multiple venturi lines, multiple venturis, multiple manifolds and multiple set of plurality of extending outlets, back to the plurality of conduits of the module. The discharge pump, during an operative state, creates a pressure differential across the venturi line, such that change in pumping rate of the discharge pump affects an amount of air drawn by the venturi and mixed with treated wastewater. As a result, a discharge pump with changing pumping rates impacts the attribute values of wastewater treatment carried out inside the plurality of biologically active conduits of the module.

The discharge pump of the present arrangements, in this embodiment, serves as a coarse controller regulating, in a coarse manner, the attribute of wastewater treatment carried out inside the plurality of biologically active conduits of the module. Furthermore, the adjustable bypass valve serves as a fine controller regulating, in a fine manner, the attribute of wastewater treatment carried out inside the plurality of biologically active conduits of the module. As a result, at least a set of biologically active conduits within the plurality of biologically active conduits of the module carry Out wastewater treatment under the same attribute value of wastewater treatment. In one implementation of the present teachings, the discharge pump, at an operative state of changing pumping rates, impacts the attribute values of wastewater treatment and, in contrast, the bypass valve operating with a constant opening and disposed on a bypass line, which represents a bypass flow path to the venturi line, does not impact the attribute values of wastewater treatment.

### Method of Managing Treatment Attributes

In yet another aspect, the present teachings provide methods of managing an attribute of wastewater treatment. One exemplar of such methods comprises performing an obtaining element. This element includes obtaining a system for managing the attribute of wastewater treatment carried out inside a set of biologically active conduits. The system for managing the attribute of wastewater treatment comprises a recirculation inlet line, a manifold line in fluid communication with the recirculation inlet line, a venturi line connected at a venturi inlet end to the recirculation inlet line and connected at a venturi outlet end to the manifold line. Furthermore, in this system, a bypass line is connected at a bypass inlet end to the inlet line and connected at a bypass outlet end to the manifold line. In this configuration, the bypass inlet end and the bypass outlet end are separated a separating distance from the venturi inlet end and the venturi outlet, respectively. Additionally, the bypass line represents a bypass flow path to the venturi line. Further still, in this system, a venturi is disposed on the venturi line, an adjustable bypass valve is disposed on the bypass line, a manifold is coupled to the manifold line, and a set of plurality of extending outlets protrude from the manifold. The system for managing the attribute of wastewater treatment also comprises a set of plurality of biologically active conduits, each of which connect to one of the extending outlets.

The method of managing an attribute of wastewater treatment also comprises an adjusting element. This element includes adjusting settings of the adjustable bypass valve to allow: (i) changing flowrates of treated wastewater, inside the bypass line and/or the venturi line based upon the adjusting settings of the adjustable bypass valve; (ii) drawing in varying amounts of air, using the venturi, into the manifold and dispersing the varying amounts of air in treated wastewater present inside the manifold and creating different mixtures of treated wastewater and air; and (iii) contemporaneously dispensing, through the set of plurality of extending outlets into the plurality of biologically active conduits, a regulated flowrate of the different mixtures of treated wastewater and air to form, inside the plurality of biologically active conduits, a desirable attribute of wastewater treatment.

The desirable attribute is one member chosen from a group comprising average lineal feet of the plurality of biologically active conduits that form an aerobic zone, average lineal feet of the plurality of biologically active conduits that form an anoxic zone, average lineal feet of the plurality of biologically active conduits that form an anaerobic zone, average volume of the plurality of biologically active conduits that form the aerobic zone, average volume of the plurality of biologically active conduits that form the anoxic zone, average volume of the plurality of biologically active conduits that form the anaerobic zone, dissolved oxygen concentration profile inside each of the biologically active conduits, average dissolved oxygen concentration profile inside the plurality of biologically active conduits and pressure differential across the venturi.

### Bypass Valve Position-Specific Attribute Control

In adjusting settings requirement of the method of managing an attribute of wastewater treatment, when the adjustable bypass valve is completely open, the drawing includes drawing into the manifold a small or a negligible amount of air, realizing inside the plurality of biologically active conduits a completely-open-bypass-valve attribute value. In this context, the completely-open-bypass-valve attribute is one member chosen from a group comprising minimum average lineal feet of the plurality of biologically active conduits that form the aerobic zone, minimum average lineal feet of the plurality of biologically active conduits that form the anoxic zone, maximum average lineal feet of the plurality of biologically active conduits that form the anaerobic zone, minimum average volume of the plurality of biologically active conduits that form the aerobic zone, minimum average volume of the plurality of biologically active conduits that form the anoxic zone, maximum average volume of the plurality of biologically active conduits that form the anaerobic zone, minimum average dissolved oxygen concentration profile inside the biologically active conduits that form the aerobic zone and the anoxic zone, minimum average dissolved oxygen concentration profile inside the biologically active conduits that form the anaerobic zone and pressure differential across the venturi.

When the adjustable bypass valve is partially open to an intermediate extent of bypass valve capacity, the drawing includes drawing into the manifold an intermediate amount of air, realizing inside the plurality of biologically active conduits a partially-open-bypass-valve attribute value. In this context, the partially-open-bypass-valve attribute is one member chosen from a group comprising intermediate average lineal feet of the plurality of biologically active conduits that form the aerobic zone, intermediate average lineal feet of the plurality of biologically active conduits that form the anoxic zone, intermediate average lineal feet of the plurality of biologically active conduits that form the anaerobic zone, intermediate average volume of the plurality of biologically active conduits that form the aerobic zone, intermediate average volume of the plurality of biologically active conduits that form the anoxic zone, intermediate average volume of the plurality of biologically active conduits that form the anaerobic zone, intermediate average dissolved oxygen concentration profile inside the biologically active conduits that form the aerobic zone, the anoxic zone and the anaerobic zone, and pressure differential across the venturi.

When the adjustable bypass valve is completely closed, the drawing includes drawing into the manifold a maximum amount of air, realizing inside the plurality of biologically active conduits a completely-closed-bypass-valve attribute value. In this context, the completely-closed-bypass-valve attribute is one member chosen from a group comprising maximum average lineal feet of the plurality of biologically active conduits that form the aerobic zone, maximum average lineal feet of the plurality of biologically active conduits that form the anoxic zone, minimum average lineal feet of the plurality of biologically active conduits that form the anaerobic zone, maximum average volume of the plurality of biologically active conduits that form the aerobic zone, maximum average volume of the plurality of biologically active conduits that form the anoxic zone, minimum average volume of the plurality of biologically active conduits that form the anaerobic zone, maximum average dissolved oxygen concentration profile inside the biologically active conduits that form the aerobic zone and the anoxic zone, minimum average dissolved oxygen concentration profile inside the biologically active conduits that form the anaerobic zone, and pressure differential across the venturi.

### Discharge Pump Integration for Attribute Management

Obtaining element of the methods of managing an attribute of wastewater treatment includes obtaining a discharge pump and the plurality of biologically active conduits of a biological treatment module. The methods of managing an attribute of wastewater treatment further comprise recirculating, using the discharge pump, treated wastewater from the module, through multiple recirculation inlet lines, multiple manifold lines, multiple bypass lines, multiple bypass valves, multiple venturi lines, multiple venturis, multiple manifolds and multiple set of plurality of extending outlets, back to the plurality of conduits that are part of the module. In this arrangement, each of the biologically active conduits is directly connected to one of the extending outlets, and indirectly connected to one of the manifolds, one of the venturis, one of the venturi lines, one of the bypass valves, one of the bypass lines and one of the recirculation inlet lines. In the methods of managing an attribute of wastewater treatment, the recirculating requirement is, preferably, carried out to coarsely control the attribute value of wastewater treatment inside the plurality of biologically active conduits of the module, and the adjusting settings requirement is, preferably, carried out to finely control the attribute value of wastewater treatment inside the plurality of biologically active conduits of the module.

### Alternative Aerobic Zone Management Method

In yet another aspect, the present teachings provide methods for managing an attribute of wastewater treatment. One exemplar of such methods comprises obtaining a system for managing the attribute of wastewater inside a biologically active conduit.

The biologically active conduit includes a recirculation inlet line, a manifold line in fluid communication with the recirculation inlet line, a venturi line connected at a venturi inlet end to the inlet line and connected at a venturi outlet end to the manifold line, a venturi disposed on the venturi line, a manifold coupled to the manifold line, a set of plurality of extending outlets protruding from the manifold, a set of plurality of conduits, each of which connect to one of the extending outlets, and a discharge pump.

The method includes: (i) adjusting a pumping rate of the discharge pump; (ii) receiving inside bypass line and/or the venturi line varying flow rates of treated wastewater; (iii) drawing in varying amounts of air, using the venturi, into the manifold and dispersing the air mixed with treated wastewater present inside the manifold to create a mixture of treated wastewater and air; and (iv) contemporaneously dispensing, through the set of plurality of extending outlets into a multiple set of conduits, varying flowrates of the mixture of treated wastewater and air to realize the desired attribute value of wastewater treatment inside the plurality of biologically active conduits of the module. The method further comprises, during adjusting the pumping rate of the discharge pump, holding constant an opening of the bypass valve.

### Comprehensive Attribute Management Method

In yet another aspect, the present teachings provide different methods of managing an attribute of wastewater treatment. One exemplar of such different methods comprises adjusting a pumping rate of a discharge pump, which is part of a recirculation subassembly, to vary flowrates of treated wastewater and vary attribute values realized inside a plurality of biologically active conduits that form a biological treatment module.

The recirculation subassembly recirculates treated wastewater received from the module back to the module, and includes a recirculation inlet line, a manifold line in fluid communication with the recirculation inlet line, a venturi line connected at a venturi inlet end to the inlet line and connected at a venturi outlet end to the manifold line, a bypass line connected at a bypass inlet end to the inlet line and connected at a bypass outlet end to the manifold line. In this configuration, the bypass inlet end and the bypass outlet end are separated a separating distance from the venturi inlet end and the venturi outlet, respectively. The bypass line represents a bypass flow path to the venturi line. The recirculation subassembly further includes a venturi disposed on the venturi line, an adjustable bypass valve disposed on the bypass line, a manifold coupled to the manifold line, and a plurality of extending outlets protruding from the manifold and connecting to the plurality of biologically active conduits.

The adjusting the pumping rates of the discharge pump causes: (i) receiving inside the bypass line and/or the venturi line varying flowrates of treated wastewater; (ii) drawing in varying amounts of air, using the venturi, into the manifold and dispersing the air in treated wastewater present inside the manifold to create varying mixtures of treated wastewater and air; and (iii) the discharge pump to contemporaneously dispense, through the set of plurality of extending outlets into a multiple set of conduits, varying flowrates of the mixture of treated wastewater and air to realize varying attribute values of wastewater treatment.

The method of managing the attribute of wastewater treatment further includes establishing steady state conditions inside the wastewater treatment system using the adjusting the pumping rate of the discharge pump and obtaining a steady state attribute value of wastewater treatment. After steady state conditions are established, the method of managing the attribute of wastewater treatment proceeds to fine tuning the steady state attribute value of wastewater treatment to arrive at a desired attribute value of wastewater treatment. The fine tuning includes: (i) adjusting the adjustable bypass valve to a desired setting of opening that allows receiving inside the bypass line and/or the venturi line a desired flowrate of treated wastewater; (ii) drawing in a desired amount of air, using the venturi, into the manifold and dispersing the air inside treated wastewater present inside the manifold to create a desired mixture of treated wastewater and air, such that the discharge pump contemporaneously dispenses, through the set of plurality of extending outlets into a multiple set of conduits, a desired flowrate of the mixture of treated wastewater and air.

The attribute of wastewater treatment is one member chosen from a group comprising average lineal feet of the plurality of biologically active conduits that form an aerobic zone, average lineal feet of the plurality of biologically active conduits that form an anoxic zone, average lineal feet of the plurality of biologically active conduits that form an anaerobic zone, average volume of the plurality of biologically active conduits that form the aerobic zone, average volume of the plurality of biologically active conduits that form the anoxic zone, average volume of the plurality of biologically active conduits that form the anaerobic zone, dissolved oxygen concentration profile inside each of the biologically active conduits, average dissolved oxygen concentration profile inside the plurality of biologically active conduits and pressure differential across the venturi.

### PFAS Removal System

In yet another aspect, the present teachings provide wastewater treatment systems for removing per- and polyfluoroalkyl substances (PFAS) from wastewater. One exemplar of such wastewater treatment systems comprises a biological treatment module including a biologically active conduit defining a serpentine flow path with sequential aerobic, anoxic, and anaerobic treatment zones. The biological treatment module reduces dissolved organic matter that competes with PFAS for adsorption sites and biotransforms PFAS precursor compounds. The exemplar wastewater treatment system further comprises a disc filter subassembly disposed downstream from the biological treatment module. The disc filter assembly is designed to remove suspended solids to produce substantially suspended-solids-free wastewater.

The exemplar wastewater treatment system further still comprises a carbon treating subassembly disposed downstream from the disc filter subassembly. The carbon treating subassembly includes granular activated carbon (GAC) designed to adsorb PFAS compounds from the substantially suspended-solids-free wastewater to produce PFAS-reduced wastewater.

In this arrangement, the biological treatment module enhances performance of the carbon treating subassembly by reducing organic matter competition and extending GAC operational life.

The wastewater treatment system achieves greater than about 90% removal efficiency for long-chain PFAS compounds including perfluorooctanoic acid (PFOA) and perfluorooctane sulfonic acid (PFOS). Described below are alternate embodiments that implement optional structural components and features that may be advantageous when practicing the present arrangements and teachings.

### PFAS System Components and Configuration

The biologically active conduit, preferably, comprises: (i) aerobic biological chips containing aerobic dominant biologically active media disposed in the aerobic treatment zone, (ii) anoxic biological chips containing anoxic dominant biologically active media disposed in the anoxic treatment zone, and (iii) anaerobic biological chips containing anaerobic dominant biologically active media disposed in the anaerobic treatment zone.

The exemplar wastewater treatment systems for removing PFAS from wastewater may further comprise: (iv) an aerobic/anoxic treatment zone separator disposed between the aerobic treatment zone and the anoxic treatment zone, and (v) an anoxic/anaerobic treatment zone separator disposed between the anoxic treatment zone and the anaerobic treatment zone. The separators prevent displacement of the biological chips between treatment zones.

The carbon treating subassembly is designed to remove at least one compound chosen from a group comprising perfluorooctanoic acid (PFOA), perfluorooctane sulfonic acid (PFOS), perfluorohexane sulfonic acid (PFHxS), perfluorononanoic acid (PFNA), and perfluorobutanesulfonic acid (PFBS).

The system further comprises a venturi system disposed at or near the aerobic treatment zone for introducing air to enhance aerobic bacterial activity and improve biotransformation of PFAS precursor compounds.

### PFAS System Performance and Operational Parameters

The biological treatment module reduces dissolved organic carbon (DOC) by at least 80% to minimize competition with PFAS compounds for GAC adsorption sites. The wastewater treatment systems for removing PFAS from wastewater further comprises an ultraviolet disinfection module disposed downstream from the carbon treating subassembly for destroying any remaining PFAS compounds through photolysis.

The GAC has a bed depth of at least 3 feet and an empty bed contact time of at least about 10 minutes to optimize PFAS removal efficiency. The biological treatment module extends GAC operational life by at least about 25% compared to GAC systems without biological pre-treatment.

The wastewater treatment systems for removing PFAS from wastewater may further comprise a recirculation system for returning treated effluent to the biological treatment module to enhance PFAS precursor biotransformation through increased contact time. The wastewater treatment systems for removing PFAS from wastewater are, preferably, designed to treat wastewater containing PFAS concentrations ranging from about 10 ng/L to about 1000 μg/L.

### PFAS System Monitoring and Advanced Treatment

The wastewater treatment systems for removing PFAS from wastewater may further comprise monitoring equipment for measuring PFAS concentrations before and after the carbon treating subassembly to verify removal efficiency. The biological treatment module includes bacterial communities chosen from a group comprising Pseudomonas species, Acidimicrobium species, and Gordonia species known to biotransform PFAS precursor compounds. The disc filter subassembly removes particles greater than about 10 microns to prevent GAC fouling and maintain optimal PFAS adsorption capacity.

The wastewater treatment systems for removing PFAS from wastewater may further comprise a regeneration system for the GAC that includes thermal reactivation at temperatures between about 800° C. and about 900° C. to restore PFAS adsorption capacity. The serpentine flow path provides a hydraulic retention time ranging between about 1 hour and about 8 hours in the biological treatment module to ensure adequate PFAS precursor biotransformation.

The wastewater treatment systems for removing PFAS from wastewater may further comprise a secondary carbon treating stage with virgin GAC disposed downstream from the carbon treating subassembly to achieve PFAS concentrations below about 10 ng/L in the PFAS-reduced wastewater.

### PFAS Removal Methods

In yet another aspect, the present teachings provide methods for removing per- and polyfluoroalkyl substances (PFAS) from wastewater. One exemplar of such methods comprises biologically treating wastewater in a serpentine conduit having sequential aerobic, anoxic, and anaerobic treatment zones to reduce dissolved organic matter and biotransform PFAS precursor compounds.

The biologically treating wastewater includes: (i) aerobically treating wastewater with aerobic bacteria to complete biotransformation processes and reduce competing organic matter; (ii) anoxically treating wastewater with anoxic bacteria to continue degradation of polyfluorinated intermediates; and (iii) anaerobically treating wastewater with anaerobic bacteria to initiate biotransformation of fluorinated precursor compounds.

The present methods for removing PFAS from wastewater comprises filtering the biologically treated wastewater through a disc filter to remove suspended solids and produce substantially suspended-solids-free wastewater, and adsorbing PFAS compounds from the substantially suspended-solids-free wastewater using granular activated carbon (GAC) to produce PFAS-reduced effluent.

The biological treating wastewater enhances GAC adsorption efficiency by reducing dissolved organic matter that competes with PFAS for adsorption sites. The methods for removing PFAS from wastewater achieve removal of at least about 90% of long-chain PFAS compounds and at least about 70% of short-chain PFAS compounds from wastewater.

### PFAS Methods Process Control and Optimization

The biologically treating wastewater includes maintaining different dissolved oxygen levels in each treatment zone, comprising maintaining dissolved oxygen levels above about 2 mg/L in the aerobic treatment zone, maintaining dissolved oxygen levels between about 0.2 and about 2.0 mg/L in the anoxic treatment zone, and maintaining dissolved oxygen levels below about 0.2 mg/L in the anaerobic treatment zone.

The biotransforming of PFAS precursor compounds includes degrading fluorotelomer compounds selected from 6:2 fluorotelomer sulfonic acid, 8:2 fluorotelomer alcohol, and 6:2 fluorotelomer sulfonamide compounds. The method further comprises monitoring fluoride ion concentration in the biologically treated wastewater as an indicator of successful PFAS precursor biotransformation. The biological treating reduces dissolved organic carbon (DOC) concentration by at least about 80% to enhance subsequent GAC adsorption efficiency.

The present methods for removing PFAS from wastewater may further comprise adjusting pH to between about 6.5 and about 8.5 during the biological treating to optimize bacterial activity for PFAS precursor biotransformation. The adsorbing using GAC includes maintaining an empty bed contact time of at least about 10 minutes to achieve optimal PFAS removal efficiency.

### PFAS Methods Advanced Treatment and Enhancement

The methods for removing PFAS from wastewater may further comprise pre-oxidizing wastewater with ozone prior to the biological treating to break down complex PFAS precursor compounds into more biodegradable intermediates. These methods may further include recirculating a portion of the biologically treated wastewater back to the anaerobic treatment zone to enhance PFAS precursor biotransformation through extended contact time. The filtering through the disc filter removes particles larger than 10 microns to prevent GAC fouling and maintain consistent PFAS adsorption performance.

The methods for removing PFAS from wastewater may further comprise monitoring GAC breakthrough by measuring PFAS concentrations in the PFAS-reduced effluent and replacing GAC media when PFAS removal efficiency drops below about 85%. The methods for removing PFAS from wastewater may include inoculating the biological treatment zones with bacterial cultures selected from Pseudomonas species, Gordonia species, and Acidimicrobium species to enhance PFAS precursor biotransformation. The biological treating wastewater may include providing electron donors selected from lactate, acetate, and methanol to support reductive biotransformation of PFAS precursor compounds in the anaerobic treatment zone.

### PFAS Methods Regeneration and Final Treatment

The methods for removing PFAS from wastewater, preferably, further comprise thermally regenerating spent GAC at temperatures between about 800° C. and about 900° C. to restore PFAS adsorption capacity and enable GAC reuse.

The methods for removing PFAS from wastewater may include treating the PFAS-reduced effluent with ultraviolet light to photolytically destroy any remaining short-chain PFAS compounds. The method treats wastewater containing initial PFAS concentrations between about 10 ng/L and about 1000 μg/L and produces effluent with PFAS concentrations below about 10 ng/L.

The methods for removing PFAS from wastewater may further comprise analyzing wastewater for PFAS compounds chosen from a group comprising perfluorooctanoic acid (PFOA), perfluorooctane sulfonic acid (PFOS), perfluorohexane sulfonic acid (PFHXS), perfluorononanoic acid (PFNA), perfluorodecanoic acid (PFDA), perfluorobutanesulfonic acid (PFBS), perfluorohexanoic acid (PFHXA), and perfluorobutanoic acid (PFBA) to verify comprehensive PFAS removal across compound classes.

The systems and methods of operation and effective compositions obtained from the present teachings and arrangements, however, together with additional objects and advantages thereof, will be best understood from the following descriptions of specific embodiments when read in connection with the accompanying figures.

### BRIEF DESCRIPTION OF THE DRAWINGS

FIG. 1 shows a schematic of a wastewater treatment system, according to one embodiment of the present arrangements, including a wastewater treatment subsystem comprising one or more biological treatment modules.

FIG. 2 shows a top view of a portion of a wastewater treatment subsystem, according to preferred embodiments of the present arrangements, including multiple biological treatment modules connected to an exemplar post treatment subassembly.

FIG. 3 shows a side view the wastewater treatment subsystem and the exemplar post treatment subassembly shown in FIG. 2.

FIG. 4 shows a top view of one of the biological treatment modules shown in FIG. 2.

FIG. 5A shows an end view of the biological treatment module shown in FIG. 4 including certain components and/or features of a recirculation subassembly, according to one embodiment of the present arrangements and that are used in managing attribute of wastewater treatment inside biologically active conduits, which form the module.

FIG. 5B shows an isometric view of the certain components and/or features of the recirculation subassembly shown in FIG. 5A.

FIG. 6 show a side view of the biological treatment module shown in FIG. 2, according to one embodiment of the present arrangements, contained therein biological media to form different treatment zones.

FIG. 7A shows a side view of an arrangement of an automatic recirculation valve and a discharge pump, according to one embodiment of the present arrangements, disposed after a biological treatment module (e.g., the second biological treatment module shown in FIG. 2) and before the exemplar post treatment subassembly shown in FIG. 2.

FIG. 7B shows an end view of the arrangement of an automatic recirculation valve and a discharge pump shown in FIG. 7A.

FIG. 8 shows a top view of a flow path, according to one embodiment of the present arrangements, extending from a recirculation inlet line associated with a biological treatment module (e.g., the second biological treatment module shown in FIG. 2) to and through the exemplar post treatment subassembly shown in FIG. 2.

FIG. 9 shows a magnified side view of the exemplar post treatment subassembly shown in FIGS. 2 and 3 and includes a chlorine dosage tank.

FIG. 10 shows a magnified end view of the exemplar post treatment subassembly shown in FIGS. 2 and 3.

FIG. 11 shows another magnified end view of a present arrangement surrounding the chlorine dosage tank shown in FIG. 9, according to one embodiment of the present arrangements.

FIG. 12 shows a flow chart of a wastewater treatment method, according to preferred embodiments of the present teachings.

FIG. 13 shows a flow chart of a method for assembling, according to preferred embodiments of the present teachings, wastewater treatment systems of the present arrangements.

FIG. 14 shows a flowchart of managing an attribute of a wastewater treatment, according to one embodiment of the present teachings.

### DETAILED DESCRIPTION OF THE DRAWINGS

In the following description, numerous specific details are set forth in order to provide a thorough understanding of the present teachings and arrangements. It will be apparent, however, to one skilled in the art that the present teachings and arrangements may be practiced without limitation to some or all these specific details. In other instances, well-known process steps have not been described in detail in order to not unnecessarily obscure the present teachings and arrangements.

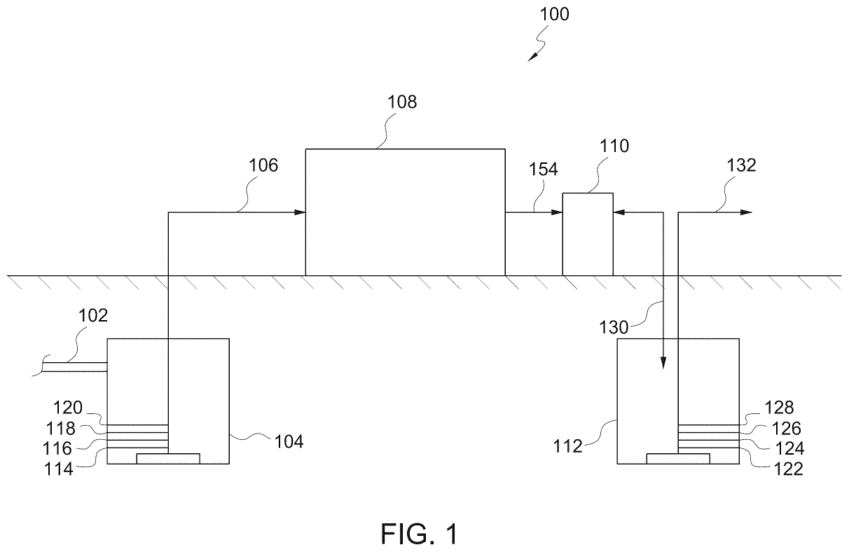

FIG. 1 shows a schematic of a wastewater treatment system 100, according to one embodiment of the present arrangements, presenting the salient components and features involved in an overall flow of the present teachings.

Wastewater treatment system 100 of FIG. 1 begins at inlet 102, which receives domestic and commercial waste including sink and sewage waste and flows into an equalization tank 104. From equalization tank 104, wastewater flows through an influent line 106 feeding into a downstream wastewater treatment subsystem 108 that includes one or more biological treatment modules. As a result, equalization tank 104 stores and regulates influent wastewater flow downstream for treatment. In preferred embodiments, equalization tank 104 of the present arrangements serves as a buffer, storing wastewater before the commencement of a treatment process. Equalization tank 104 also affords an opportunity to balance the flow and composition of wastewater, ensuring a consistent input for downstream treatment.

Briefly, each biological treatment module, comprising the downstream treatment, contains multiple treatment zones where different types of resident bacteria process the wastewater. Examples of such treatment zones includes aerobic, anoxic and anaerobic treatment zones. Furthermore, if a biological treatment module is made from a plurality of conduits, then, preferably, each of the conduits has disposed therewithin aerobic, anoxic and anaerobic treatment zones and serves as a biological filter.

The present teachings also contemplate using multiple biological modules, where each biological module is dedicated to a single type of biological treatment of wastewater. In one embodiment of this arrangement, one biological module is dedicated to aerobic treatment, another biological module is dedicated to anoxic treatment, and yet another biological module is dedicated to anaerobic treatment.

Regardless of the embodiment deployed, after primary treatment concludes in one or more of the biological modules of wastewater treatment subsystem 108, treated wastewater flows, through post treatment water line 130, preferably, to a post treatment subassembly 110, which provides additional treatment and purification. In preferred embodiments of the present arrangements, post treatment subassembly 110 includes a treated water tank 112 for storing the ultimately resulting treated wastewater that is deemed recycled water. In these embodiments, a recycled water line 132 discharges recycled water that may be used in a variety of applications including irrigation. For the irrigation application specifically, the ultimately produced treated wastewater complies with the requisite regulatory standards to be deemed as “irrigatable” water.

FIG. 1 shows an exemplar approach, using one embodiment of the present arrangements, to manage wastewater flow from initial collection in the equalization tank, through the biological treatment modules with their specialized bacteria zones, to the post-treatment phase, and finally to storage in the treated water tank 112. The sensors and switches ensure automatic operation of the system based on water levels in the tanks.

The present arrangements represent an innovative approach to wastewater treatment using a conduit with multiple discrete treatment zones, each containing different types of bacteria to efficiently treat different aspects of wastewater.

In FIG. 1, an off switch 116 functions in conjunction with low-level sensor 114, which detects and generates a signal, e.g., “low-level” signal, indicating a condition of a wastewater level being at or below a predefined minimum threshold inside equalization tank 104. When low-level sensor 114 is triggered and signals that equalization tank 104 is nearly empty or, stated another way, that the water level inside equalization tank 104 is at or below the predefined minimum threshold, off switch 116 automatically shuts off one or more pumps that draw wastewater from equalization tank 104 preventing pumps from running dry and damaging equipment.

Similarly, an on switch 118 functions in conjunction with a high-level sensor 120, which detects and generates a signal, e.g., “high-level” signal, indicating a condition of a wastewater level being at or above a predefined maximum threshold inside equalization tank 104. When high-level sensor 120 is triggered and signals that equalization tank 104 is at maximum capacity or, stated another way, that the water level inside equalization tank 104 is too high at or above the predefined minimum threshold, on switch 118 activates alarms, emergency overflow systems or additional pumps to increase the rate of wastewater removal preventing overflow of equalization tank 104. Upon activation of on switch 118, wastewater inside equalization tank 104 is preferably consistently pumped at a faster rate, through influent line 106, to the downstream biological treatment modules in wastewater treatment subassembly 108 until the maximum capacity condition no longer exists. In wastewater treatment subassembly 108, each of the biological treatment modules include multiple different zones (e.g., aerobic, anoxic, and/or anaerobic) with specific types of bacteria that break down various contaminants in the wastewater. Each biological treatment module contains biological chips populated with different bacteria strains appropriate for that treatment zone.

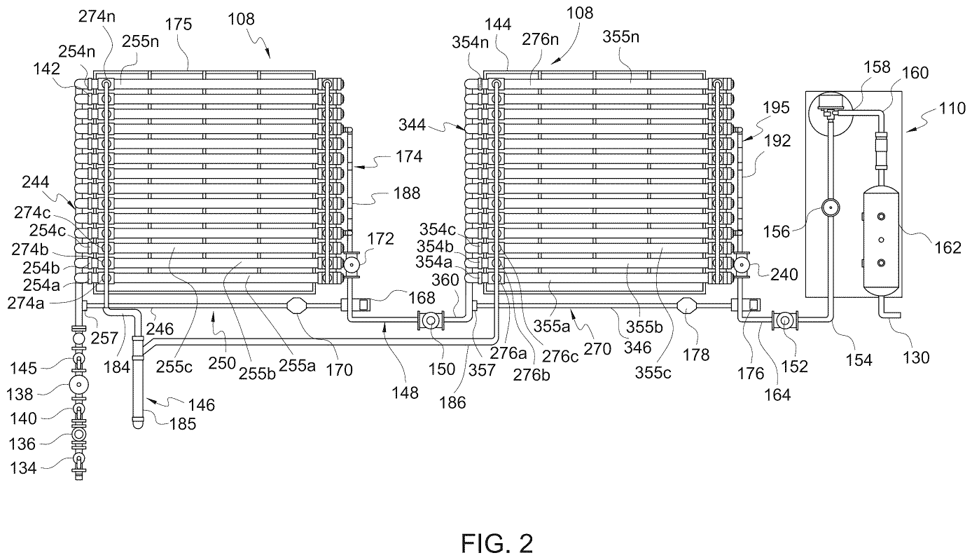

Post wastewater treatment subassembly 110 provides final treatment steps after the biological processes, such as filtration, UV disinfection, and chemical treatment like chlorination, as explained in connection with FIG. 2, to ensure the treated wastewater meets the desired quality standards before storage. A post treatment water line 130 carries the fully treated wastewater from post treatment subassembly 110 into a treated water tank 112 for storage before distribution or reuse.

Low level sensor 114, off switch 116, on switch 118 and high-level sensor 120 operating in connection with equalization tank 104 are substantially similar to their counterparts, e.g., a low-level sensor 122, an off switch 124, an on switch 126 and a high-level sensor 128 operating in conjunction with treated water tank 112. By way of example, off switch 124 functions in conjunction with low-level sensor 122, which detects and generates a signal, e.g., “low-level” signal, indicating a condition of a wastewater level being at or below a predefined minimum threshold inside treated water tank 112. When low-level sensor 122 is triggered and signals that treated water tank 112 is nearly empty or, stated another way, that the water level inside treated water tank 112 is at or below the predefined minimum threshold, off switch 124 automatically shuts off one or more pumps that draw wastewater from treated water tank 112 preventing pumps from running dry and damaging equipment.

Similarly, on switch 126 functions in conjunction with high-level sensor 128, which detects and generates a signal, e.g., “high-level” signal, indicating a condition of a wastewater level being at or above a predefined maximum threshold inside treated water tank 112. When high-level sensor 128 is triggered and signals that treated water tank 112 is at maximum capacity or, stated another way, that the water level inside treated water tank 112 is too high at or above the predefined minimum threshold, on switch 126 activates alarms, emergency overflow systems or additional pumps to increase the rate of wastewater removal preventing overflow of treated water tank 112. Upon activation of on switch 126, wastewater inside treated water tank 112 is preferably consistently pumped at a faster rate, through recycled water line 132, to a downstream recycled water storage tank until the maximum capacity condition no longer exists.

Other than using treated wastewater for irrigation, as mentioned above, recycled water line 132 may be used for returning partially treated water to earlier stages for additional processing if the desired water quality parameters are not met, maintaining bacterial cultures in the biological treatment modules by ensuring consistent flow, and/or optimizing treatment efficiency by allowing water to undergo multiple passes through the treatment process.

As a result, wastewater treatment system 100 of FIG. 1 operates as an integrated unit, with the sensors and switches providing automated control over water flow and treatment processes. The system is designed to efficiently treat wastewater using biological processes in multiple zones, creating a cost-effective solution particularly for relatively low volumes of wastewater.

FIG. 2 shows a top view of a portion of wastewater treatment system 100 of FIG. 1, according to one embodiment of the present arrangements. This portion of wastewater treatment system 100 of FIG. 1 includes wastewater treatment subassembly 108, post wastewater treatment subassembly 110 and influent line 106 including components and features associated therewith. By way of example, influent line 106 includes such components as a first isolation ball valve 134, an influent automatic valve 136, a second isolation ball valve 140, an influent grit solid screen 138, a third isolation ball valve 145, an overflow subassembly 146, a first module influent manifold 244, a second module influent manifold 344, a first module post treatment subassembly 250 and a second module post treatment subassembly 270.

According to FIG. 2 and in connection with influent line 106, isolation ball valves used in the design of wastewater treatment system 100 of FIG. 1 may serve one or more functions. By way of example, first isolation ball valve 134 may control initial flow of wastewater into wastewater treatment system 100 of FIG. 1 and, in conjunction with second isolation ball valve 140, allows isolation of influent automatic valve 136 during maintenance. Similarly, second isolation ball valve 140 and third isolation ball valve 145 control flow of wastewater into wastewater treatment system 100 of FIG. 1 and allow isolation of influent grit solid screen 138 during maintenance.

Influent automatic valve 136 regulates flow of wastewater inside influent line 106 and influent grit solid screen 138 removes larger solid particles from wastewater before biological treatment inside wastewater treatment subassembly 108. Influent grit solid screen 138 effectively removes solids having a largest dimension that ranges between about 0.2 mm and about 4 mm, with densities predominantly above about 1800 kg/m³1. A general performance criterion for influent grit solid screen 138 is to effectively remove about 95% of solids above about 210 μm in size.

Wastewater treatment subassembly 108 includes one or more biological treatment modules (hereinafter “modules”). Preferably, wastewater treatment subassembly 108 includes a first module 142 and a second module 144, each of which comprises a plurality of parallelly extending biologically active conduits 255a, 255b, 255c . . . 255n and 355a, 355b, 355c . . . 355n, respectively, where n is whole number, preferably, greater than 3. FIGS. 2-6 show that each of biologically active conduits 255a, 255b, 255c . . . 255n, 355a, and 355b, 355c . . . 355n define a single, confined serpentine flow path that twists from a top portion, through a middle portion, to a bottom portion.

Influent line 106, preferably through a first module influent manifold 244, are in fluid communication with each of biologically active conduits 255a, 255b, 255c . . . 255n. As shown in the embodiment of FIG. 2, first module influent manifold 244 has disposed thereon a plurality of first module influent manifold outlets 254a, 254b, 254c . . . 254n, which are connected to respective bottom openings defined at a bottom portion of biologically active conduits 255a, 255b, 255c . . . 255n. As a result, wastewater is introduced, through these bottom openings of biologically active conduits 255a, 255b, 255c . . . 255n, at a bottom portion in first module 142.

When wastewater treatment subassembly 108 shown in FIG. 2 is operating under certain settings discussed below, wastewater present inside influent line 106 is conveyed, through certain components of first module post treatment subassembly 250 (e.g., a first module post treatment conduit 148) and a second module influent manifold 344, to second module 144.

As shown in the embodiment of FIG. 2, like first module influent manifold 244, second module influent manifold 344 has disposed thereon a plurality of second module influent manifold outlets 354a, 354b, 354c . . . 354n, where n is whole number, preferably, greater than 3. Second module influent manifold outlets 354a, 354b, 354c . . . 354n are connected to respective bottom openings defined at a bottom portion of biologically active conduits 355a, 355b, 355c . . . 355n. As a result, wastewater is introduced, through these bottom openings of biologically active conduits 355a, 355b, 355c . . . 355n, at a bottom portion in second module 144.

FIG. 2 also shows a single overflow subassembly for removing excess wastewater present inside first module 142 and second module 144 from their respective outlets. An overflow subassembly 146 includes a first module overflow line 184 and a second module overflow line 186. First module overflow line 184 has disposed thereon a plurality of first module overflow outlets 274a, 274b, 274c . . . 274n, which are connected to respective inlets disposed at a top portion of each of biologically active conduits 255a, 255b, 255c . . . 255n. Similarly, second module overflow line 186 has disposed thereon a plurality of second module overflow outlets 276a, 276b, 276c . . . 276n, which are connected to respective inlets disposed at a top portion of each of biologically active conduits 275a, 275b, 275c . . . 275n. First module overflow line 184 and second module overflow line 186 preferably share a common component or feature, i.e., an overflow outlet return line 185, for conveying wastewater back to equalization tank 104 shown in FIG. 1.

According to the present arrangements, a module is connected to a post treatment subassembly that conveys wastewater treated in and from the module to a recirculation subassembly, another module for further biological treatment, or a post treatment subsystem.

FIG. 2 shows first module 142 connected to a first module post treatment subassembly 250, which includes a first module effluent outlet 257, first module effluent conduit 246, a first module solid grit screen 170, a first module discharge pump 168. Depending on the operational state, i.e., open or closed, of first recirculation line automatic valve 172 and first automatic valve 150, discharge pump 168 conveys wastewater treated inside first module 142 either back to first recirculation subassembly 174 or downstream, through first module post treatment conduit 148, to second module 144 for further biological treatment.

Some of the same conveyances that provide influent inside first module 142 comprising first module influent manifold 244 and influent line 106 also facilitate conveyance of treated wastewater present inside first module 142 to a downstream location (e.g., first recirculation subassembly 174 or second module 144) for further treatment. To this end, first module influent manifold 244 is connected to influent line 106, which is, in turn, connected to first module effluent outlet 257 that is part of first module post treatment subassembly 250. According to FIG. 2, as wastewater flows inside first module post treatment subassembly 250, it passes through first module solid grit screen 170 to effectively remove solids having a largest dimension that ranges between about 0.2 mm and about 4 mm, with densities predominantly above about 1800 kg/m³1. A general performance criterion for influent grit solid screen 138 is to effectively remove about 95% of solids above about 210 μm in size.

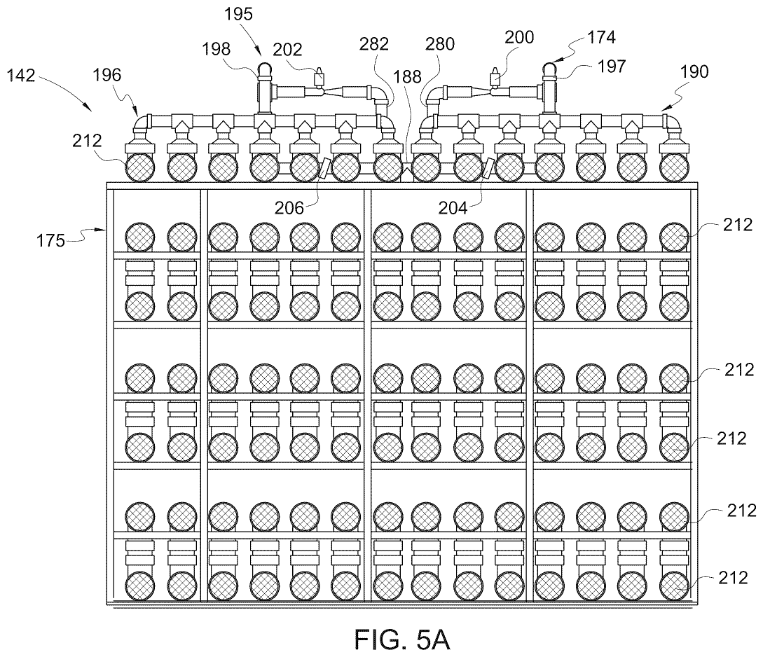

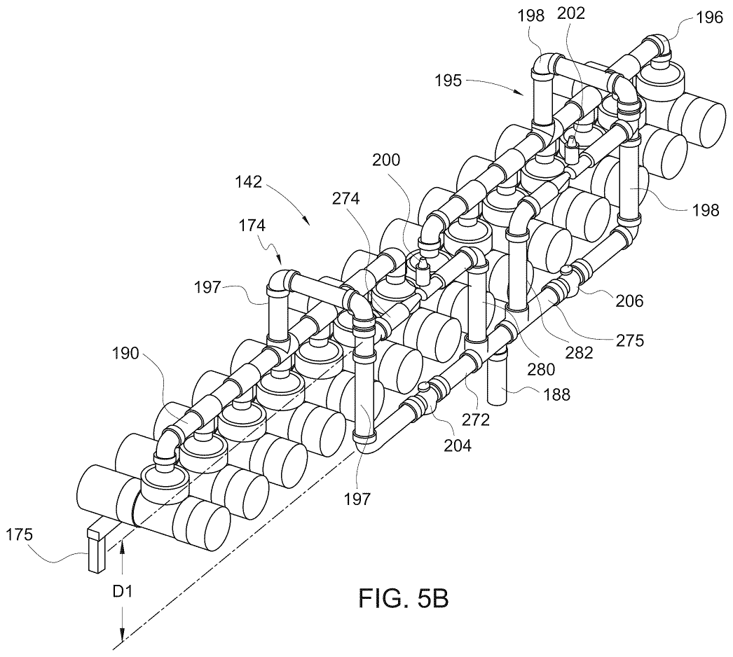

If a first recirculation line automatic valve 172 is in an “open” position and a first automatic valve 150 disposed after first module 142 in a “closed” position, then first module discharge pump 168 recirculates, using first recirculation subassembly 174, wastewater treated inside first module 142 back to first module 142. Furthermore, if first recirculation line automatic valve 172 is in a “closed” position and first automatic valve 150 is in an “open” position, then first module discharge pump 168 advances wastewater treated inside first module 142, through a second module influent line 360 to second module 144 for further biological treatment. Components and features that comprise first recirculation subassembly 174 are shown in detail in FIG. 5.

As first module discharge pump 168 advances wastewater through a first module post treatment conduit 148, a first automatic valve 150 regulates treated wastewater flow inside second module influent line 360 to second module influent manifold 344 described above. As explained above, second module influent manifold outlets 354a, 354b, 354c . . . 354n, which are part of second module influent manifold 344, are connected to respective inlets of biologically active conduits 355a, 355b, 355c . . . 355n.

Second module 144 is connected to a second module post treatment subassembly 270, which includes a second module effluent outlet 357, a second module effluent conduit 346, a second module solid grit screen 178, a second module discharge pump 176. In this configuration, second module discharge pump 176 conveys wastewater treated inside second module 144 either to a second recirculation subassembly 195 or to post treatment subassembly 110. Inside the post treatment subassembly 110, wastewater from the module undergoes treatment, preferably, that is not biological in nature as it does in a module of the present arrangements.

Some of the same conveyances, such as second module influent manifold 344 and second module influent line 360, that provide treated wastewater influent inside second module 144 also facilitate conveyance of treated wastewater from second module 144 to a downstream location (e.g., second recirculation subassembly 195 or post treatment subassembly 110) for further treatment. To this end, second module influent manifold 344 is connected to second module influent line 360, which is, in turn, connected to second module effluent outlet 357 that is part of second module post treatment subassembly 270. According to FIG. 2, as wastewater flows inside second module post treatment subassembly 270, it passes through second module solid grit screen 178 to effectively remove solids having a largest dimension that ranges between about 0.2 mm and about 4 mm, with densities predominantly above about 1800 kg/m³1. A general performance criterion for influent grit solid screen 138 is to effectively remove about 95% of solids above about 210 μm in size.

If a second recirculation line automatic valve 240 is in an “open” position and a second automatic valve 152 disposed after second module 144 in a “closed” position, then second module discharge pump 176 recirculates, using second recirculation subassembly 195, wastewater treated inside second module 144 back to second module 144. Second recirculation subassembly 195 is substantially similar to first recirculation subassembly 174 shown in FIG. 5. If, however, second recirculation line automatic valve 240 is in a “closed” position and second automatic valve 152 is in an “open” position, then second module discharge pump 176 advances wastewater treated inside and from second module 144, through a second module post treatment conduit 164, to post treatment subassembly 110.

In the configuration of FIG. 2, post treatment subassembly 110 includes an post treatment influent line 154, a disc filter 156, an activated carbon 158, a UV disinfection module 160, a chlorine treatment subassembly 162 preferably including a chlorine injection apparatus, and a post treatment water line 130 that conveys treated water into a treated water tank (e.g., treated water tank 112 shown in FIG. 1). Disc filter 156 is deployed for removing remaining suspended solids, activated carbon 158 serves to remove organic compounds and contaminants present in wastewater flowing inside post treatment influent line 154, UV disinfection module 160 is designed to kill microorganisms and chlorine treatment subassembly 162 is designed to provide final disinfection.

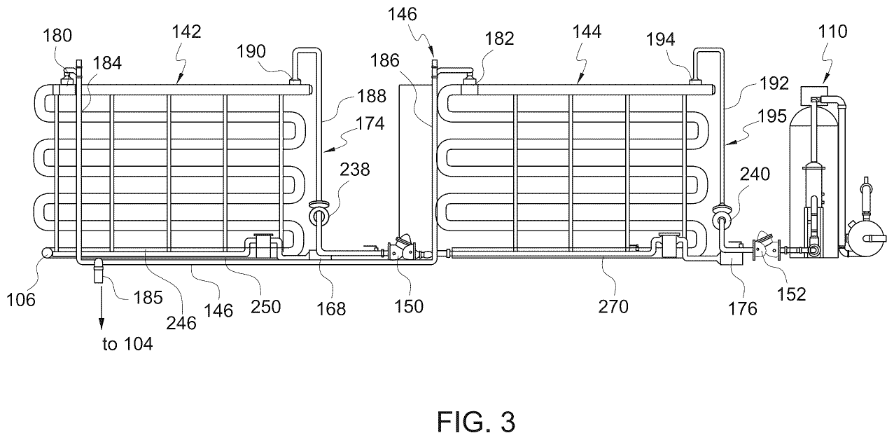

FIG. 3 shows how features and components comprising wastewater treatment subassembly 108 and post treatment subassembly 110 are arranged and interconnected to provide efficient, multi-stage treatment of wastewater. In this figure, certain features and components are not shown to simplify illustration and obscure the advantageous aspects of the present teachings. By way of example, influent line 106 is shown entering first module 142, without showing certain valves disposed along influent line 106. FIG. 3, however, clearly shows that influent line 106 introduces wastewater at a bottom portion of first module 142, which represents a preferred embodiment of the present arrangements.

FIG. 3 also shows a side view of a portion of wastewater treatment system 100 of FIG. 1, depicting the spatial relationships and vertical integration of major system components. Wastewater treatment subassembly 108 includes first module 142 and second module 144, which contain the biological treatment conduits arranged in parallel configurations for sequential wastewater processing. Post wastewater treatment subassembly 110 is positioned downstream from the biological modules to receive treated effluent for activated carbon adsorption, polishing and/or disinfection.

Equalization tank 104 serves as the wastewater storage and flow regulation component, connected to the biological treatment system through influent line 106. First module 142 is positioned upstream for initial biological treatment, while second module 144 is positioned downstream for secondary biological treatment processes.

The recirculation systems include first recirculation subassembly 174 comprising first manifold 190 for recirculation in first module 142, which receives treated wastewater through first module recirculation conduit 188. First recirculation automatic valve 238 controls the recirculation flow within the first module system. Second recirculation assembly 195 includes second manifold 194 for recirculation in second module 144, connected through second module recirculation conduit 192, with second recirculation automatic valve 240 managing recirculation flow for the second module.

Flow control components include first automatic valve 150 that regulates treated wastewater advancement from first module 142, and second automatic valve 152 that controls flow advancement from second module 144 to post treatment subassembly 110. First module discharge pump 168 provides motive force for moving treated effluent from first module 142, while second module discharge pump 176 performs the same function for second module 144.

FIG. 3 clearly shows that overflow subassembly 146 includes a first module overflow manifold 180 positioned above first module 142 and second module overflow manifold 182 positioned above second module 144. First module overflow conduit 184 connects first module overflow manifold 180 to an overflow return system, while second module overflow conduit 186 connects second module overflow manifold 182 to the same return pathway. Both overflow conduits converge into overflow outlet return line 185 that directs excess wastewater back to equalization tank 104.

Post-treatment management includes first module post treatment subassembly 250 that facilitates either recirculation within first module 142 or advancement to second module 144, and second module post treatment subassembly 270 that enables either recirculation within second module 144 or advancement to post treatment subassembly 110. First module effluent conduit 246 conveys treated wastewater from first module 142 for subsequent processing or recirculation. Similarly, second module effluent conduit 346 conveys treated wastewater from second module 144 for subsequent processing or recirculation.

The side view perspective of FIG. 3 reveals the vertical flow dynamics. Wastewater flows through the serpentine treatment conduits within each module following the twisted flow path from top portion through middle portion to bottom portion. When treatment modules reach capacity, excess wastewater exits through top outlets and flows to the overflow manifolds positioned above the modules. This vertical arrangement enables first module overflow manifold 180 and second module overflow manifold 182 to collect excess wastewater, which then travels through first module overflow conduit 184 and second module overflow conduit 186 respectively, before combining in overflow outlet return line 185 for return to equalization tank 104.

The recirculation operation benefits from the vertical configuration where first module discharge pump 168 creates sufficient head pressure to recirculate treated wastewater through first module recirculation conduit 188 to first manifold 190, while first recirculation automatic valve 238 coordinates with first automatic valve 150 to ensure proper flow direction. When recirculation is required, first recirculation automatic valve 238 opens while first automatic valve 150 closes, maintaining treatment within first module 142. Similarly, second module discharge pump 176 recirculates wastewater through second module recirculation conduit 192 to second manifold 194 when second recirculation automatic valve 240 is open and second automatic valve 152 is closed.

The side view of FIG. 3 distinctly illustrates the space-efficient design achieved through the strategic wrapping arrangement of overflow subassembly 146 and recirculation subassemblies 174 and 195 around their respective modules. First module overflow manifold 180 and second module overflow manifold 182 are positioned directly above their corresponding treatment modules, utilizing vertical airspace that would otherwise remain unused in conventional horizontal treatment system layouts.

The wrapping configuration of first module overflow conduit 184 and second module overflow conduit 186 around the perimeter of the modules eliminates the need for extensive horizontal piping runs that would require additional ground space. This vertical integration approach, combined with the compact routing of overflow outlet return line 185, significantly reduces the overall system footprint compared to traditional treatment systems where overflow management requires separate horizontal space allocation.

The recirculation subassemblies 174 and 195 demonstrate similar space efficiency through their wrapping design. First module recirculation conduit 188 and second module recirculation conduit 192 are routed around their respective modules rather than extending linearly, while first manifold 190 and second manifold 194 are positioned to maximize the use of available vertical and horizontal space without expanding the system's perimeter.

This integrated wrapping design enables the wastewater treatment system to achieve comprehensive biological treatment, recirculation capabilities, and overflow protection within a dramatically reduced real estate footprint. The vertical stacking and perimeter wrapping of essential components makes the system ideal for space-constrained installations such as urban facilities, industrial sites with limited available area, and retrofit applications where conventional treatment systems would be impractical due to extensive spatial requirements. The compact configuration achieved through the wrapping arrangement of overflow and recirculation subassemblies represents a significant advancement in wastewater treatment system design, enabling advanced biological treatment capabilities in applications previously limited by space constraints. The space-efficient design of the present wastewater treatment systems make the present arrangement ideal for installations with limited available area, such as in food processing facilities, wineries, and other industrial settings where traditional wastewater treatment systems require significantly more space.

By way of example, a module of the present arrangements has a width ranging from between about 7 feet to about 20 feet, a length ranging from about 5 feet to about 40 feet and a height ranging from about 8 feet to about 13 feet. In those instances where transportation of the module is involved and spatial dimension of a module is of concern, the module having a width of about 8 feet, a length of about 10 feet and a height of about 8 feet represents a preferred embodiment of the present arrangements.

The compact vertical integration demonstrated in FIG. 3 provides significant advantages over conventional biological wastewater treatment technologies. Traditional vermifiltration systems, which employ earthworms for biological treatment, require extensive horizontal bed areas, with typical footprints ranging from 2-15 times larger than the present arrangements of wastewater treatment systems, due to their shallow-bed configuration and requirement for worm habitat maintenance. Vermicomposting filtration systems similarly demand substantial surface area for effective worm population management and organic matter processing, making them impractical for urban installations or space-constrained industrial facilities. The wrapping configuration of overflow subassembly 146 and recirculation subassemblies 174 and 195 around the treatment modules achieves treatment capacity equivalent to much larger conventional systems, but within a dramatically reduced footprint.

This space efficiency provides critical advantages for carbon trading applications, where treatment systems must demonstrate both environmental effectiveness and economic viability. The reduced real estate footprint enables installation in urban and industrial settings where land costs make conventional technologies economically unfeasible, thereby expanding opportunities for carbon credit generation through modular wastewater treatment. Additionally, the compact design reduces construction-related carbon emissions compared to extensive vermifiltration installations, enhancing the overall carbon footprint benefits and increasing the value of associated carbon credits.

The modular, vertical design eliminates the extensive horizontal infrastructure required by vermifiltration systems, making the technology suitable for retrofit applications and dense urban environments where conventional biological treatment technologies cannot be practically implemented due to space constraints and operational complexity.

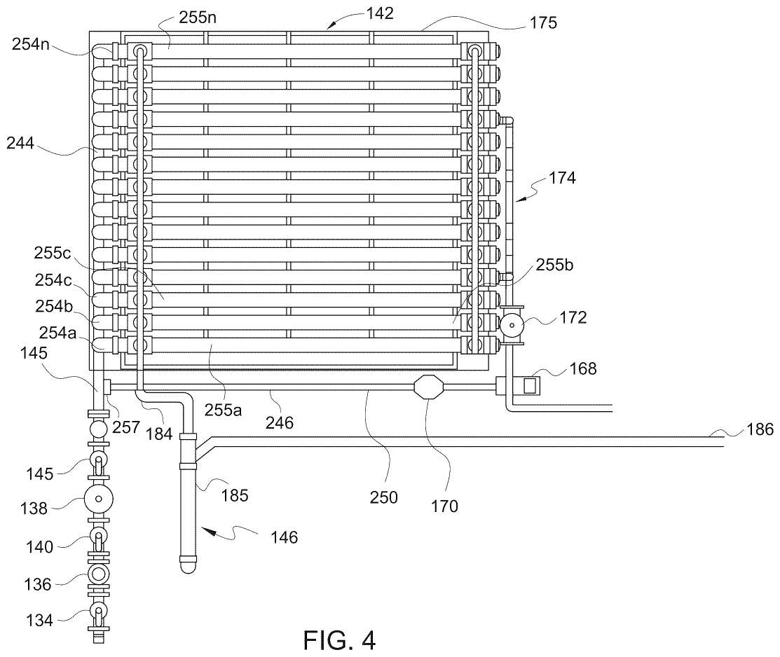

FIG. 4 shows a top view of first module 142 in isolation, providing enhanced detail of the individual components and structural features that comprise this biological treatment module. This view clearly illustrates the modular construction and component arrangement that enables efficient wastewater treatment within a compact footprint. Moreover, deploying multiple modules is not necessary and single module implementations are contemplated by the present teachings.

First module 142 is mechanically supported by first rack 175, which provides structural stability for the plurality of biologically active conduits 255a, 255b, 255c, . . . 255n that extend parallelly within the module. Each of these biologically active conduits defines a single, confined serpentine flow path and is configured to receive wastewater through respective bottom openings connected to first module influent manifold outlets 254a, 254b, 254c, . . . 254n.

First module influent manifold 244 serves as the primary distribution system for directing incoming wastewater to the individual biologically active conduits. The manifold is equipped with the plurality of outlets 254a through 254n, each specifically designed to convey wastewater from influent line 106 to the respective bottom openings of biologically active conduits 255a through 255n.

The influent flow control system includes several critical components positioned upstream of first module 142. First isolation ball valve 134 provides initial flow control and isolation capability for the influent stream. Downstream from this valve, influent automatic valve 136 automatically regulates the flow rate of incoming wastewater based on system demands and control parameters.

Second isolation ball valve 140 is strategically positioned downstream from influent automatic valve 136 to provide isolation capability for the automatic valve during maintenance operations. The positioning of first isolation ball valve 134 and second isolation ball valve 140 allows for complete isolation of influent automatic valve 136 when service or repair is required. Influent grit solid screen 138 is disposed between second isolation ball valve 140 and third isolation ball valve 145, providing mechanical filtration to remove larger solid particles from the wastewater stream before it enters the biological treatment system. This screening function protects the downstream biological treatment processes from potential damage or interference caused by oversized debris.

Third isolation ball valve 145 completes the influent flow control system by providing isolation capability for influent grit solid screen 138. The arrangement of second isolation ball valve 140 and third isolation ball valve 145 enables isolation of the grit screen for cleaning, maintenance, or replacement without disrupting flow to the entire system.

First recirculation subassembly 174 is positioned to facilitate the recirculation of treated wastewater back to first module 142. This subassembly includes first recirculation inlet line automatic valve 172, which controls the recirculation flow based on treatment requirements and system operating conditions.

First module discharge pump 168 provides the motive force necessary to move treated wastewater from first module 142 through first module effluent conduit 246 to first module effluent outlet 257. This pump enables both recirculation within first module 142 and advancement of treated wastewater to downstream treatment processes.

First module solid grit screen 170 is positioned within the effluent path to provide additional solids removal from the treated wastewater, ensuring that any remaining particulate matter is captured before the water advances to subsequent treatment stages.

Overflow subassembly 146 includes components designed to manage excess wastewater capacity within first module 142. First module overflow conduit 184 connects to the overflow system and directs excess wastewater through overflow outlet return line 185 back to equalization tank 104 for subsequent treatment cycles.

FIG. 4 also shows second module overflow conduit 186, demonstrating the integrated design approach where overflow management for multiple modules is coordinated through shared infrastructure components.

First module post treatment subassembly 250 encompasses the components and conduits that manage the flow of treated wastewater from first module 142, including provisions for either recirculation within the module or advancement to second module 144 for additional biological treatment.

The arrangement shown in FIG. 4 demonstrates the space-efficient design principles employed in the present arrangements, where multiple treatment functions are integrated within a compact modular configuration supported by first rack 175. This modular approach facilitates transportation, installation, and maintenance while providing comprehensive biological wastewater treatment capabilities within the constrained dimensional envelope of first module 142.

FIG. 5A shows an end view of first module 142, revealing the internal serpentine conduit configuration and recirculation subassembly details that are not visible in the previous top and side views. This perspective provides critical insight into the three-dimensional flow path design and the dual recirculation system architecture that enables precise control of treatment zone characteristics within the biologically active conduits.

The end view shown in FIG. 5A clearly illustrates the serpentine nature of biologically active conduits 255a, 255b, and 255c shown in FIG. 2 as they twist from top to bottom within first module 142. Each conduit follows a helical or coiled path that maximizes the treatment path length while maintaining the compact footprint of the module. This serpentine configuration creates the physical foundation for establishing the sequential aerobic, anoxic, and anaerobic treatment zones within each individual conduit.

A distinctive feature revealed in this view is the dual recirculation system comprising first recirculation subassembly 174 and second recirculation assembly 195, both serving first module 142. This dual system configuration provides enhanced control over treatment parameters by enabling independent management of different portions of the same module or different treatment phases.

First manifold 190, which is part of first recirculation subassembly 174, is positioned to receive treated wastewater through first module recirculation conduit 188. First manifold line 197 provides fluid communication between the recirculation system and first manifold 190, enabling the distribution of recirculated wastewater to select biologically active conduits.

Second manifold 196, which forms part of second recirculation assembly 195, operates in parallel with first manifold 190 but serves a distinct function within the overall recirculation strategy. Second manifold line 198 connects to second manifold 196, providing an independent pathway for recirculation control.

The air management system for controlling treatment zone characteristics includes first venturi 200 associated with first manifold 190 and second venturi 202 associated with second manifold 196. These venturis provide independent air introduction capabilities, allowing for differential oxygenation control between different portions of the same module or different treatment phases.

First bypass valve 204 functions in conjunction with first manifold 190 to regulate the proportion of recirculated wastewater that bypasses first venturi 200. This bypass capability enables, among other things, fine-tuning of the air-to-water ratio entering the treatment zones served by first manifold 190.

Similarly, second bypass valve 206 operates in conjunction with second manifold 196 to control bypass flow around second venturi 202. The independent bypass control provided by first bypass valve 204 and second bypass valve 206 allows for sophisticated management of dissolved oxygen profiles within different regions of first module 142.

The internal arrangement shows mesh 212 positioned at strategic locations within the biologically active conduits. These mesh elements serve as zone separators, preventing the displacement of biological chips between different treatment zones while allowing wastewater and treated effluent to pass through freely.

The end view perspective reveals how first rack 175 provides structural support not only for the biologically active conduits but also for the associated recirculation infrastructure. The integration of mechanical support with fluid management systems demonstrates the sophisticated engineering approach employed in the modular design.

First recirculation line 280 and second recirculation line 282 are shown associated with first recirculation subassembly 174 and second recirculation assembly 195, respectively. These components draw in treated wastewater to be subject to two independently operating venturi/bypass valve configurations that enable independent operation and optimization of the dual recirculation configuration.

The spatial relationship between the serpentine conduits and the recirculation manifolds illustrates how treated wastewater may be selectively directed to different elevation levels within the conduits, enabling control over the hydraulic residence time and treatment intensity in specific zones.

This end view demonstrates that the modular design extends beyond simple parallel arrangement of conduits to include sophisticated internal flow management that can create varying treatment conditions within a single module. The dual recirculation system architecture enables operational flexibility that allows first module 142 to be optimized for different influent characteristics or treatment objectives while maintaining the compact modular form factor.

FIG. 5B shows an isometric three-dimensional view of first module 142, revealing the actual construction methodology and interconnection architecture of the serpentine biologically active conduits. This perspective demonstrates how the single, confined serpentine flow path is physically realized through the assembly of multiple discrete pipe-sections and illustrates the sophisticated bypass line network that enables fine control of wastewater treatment attributes.

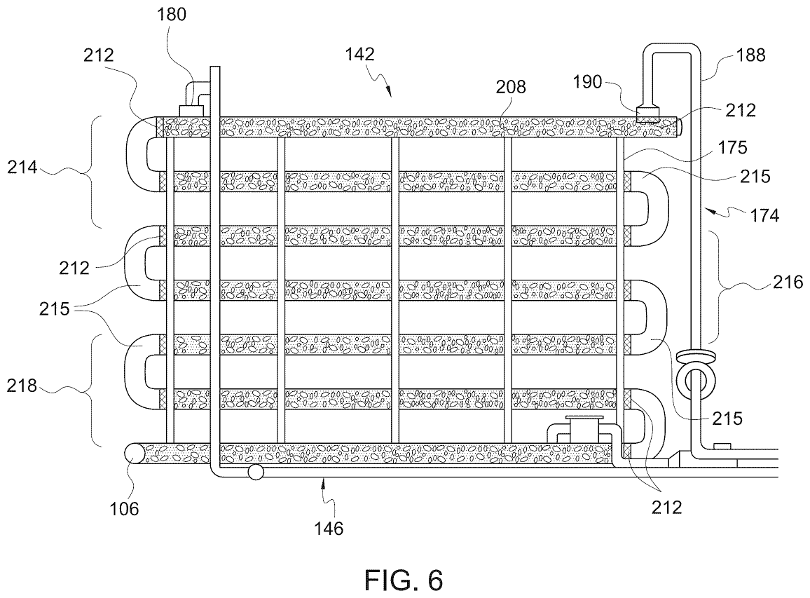

The three-dimensional view of FIG. 5B clearly shows how biologically active conduits 255a, 255b, and 255c shown in FIG. 2 are constructed from multiple interconnected pipe sections, each having linear portions and twisted portions as contemplated in the assembly methods of the present arrangements. As explained in connection with FIG. 6, linear portions provide space for biological chip placement, while twisted portions serve as transition elements that create the serpentine flow path geometry while remaining substantially free of biological chips. Absence of biological chips in twisted portions prevents undue pressure buildup in the twisted portions during fluid flow.

First bypass line 272, which is associated with first recirculation subassembly 174, provides a bypass flow path that allows treated wastewater to circumvent first venturi 200. This bypass configuration enables precise control of the air-to-wastewater ratio entering first manifold 190, thereby controlling the dissolved oxygen concentration profile within the treatment zones inside the biologically active conduits served by this manifold.

First venturi line 274 connects first venturi 200 at a venturi inlet end to first manifold line 197 and at a venturi outlet end to first manifold line 197. This venturi line arrangement creates the pressure differential necessary for air entrainment while providing a controlled flow path for the air-water mixture advancing toward first manifold 190.

Second bypass line 275 operates in parallel with first bypass line 272 but serves second recirculation assembly 195. This independent bypass capability allows for differential control of wastewater treatment attributes between different portions of first module 142 or different sets of biologically active conduits within the same module.

The isometric perspective reveals the physical separation distances between bypass inlet ends and bypass outlet ends relative to their corresponding venturi inlet ends and venturi outlets. These separating distances are critical design parameters that determine the effectiveness of the bypass flow paths in controlling the attribute values of wastewater treatment within the plurality of biologically active conduits.

Direction indicator D1 shows the orientation and flow direction within the serpentine conduits, illustrating how wastewater enters at the bottom portion and follows the confined serpentine flow path upward through the anaerobic, anoxic, and aerobic treatment zones before recirculation or discharge.

The three-dimensional view demonstrates how first rack 175 provides integrated structural support for both the serpentine conduits and the complex network of bypass lines, venturi lines, and manifold connections. This structural integration is essential for maintaining proper alignment and preventing stress concentrations that could affect system performance.

The construction approach visible in this view reveals how the modular design facilitates field assembly and maintenance access. The discrete pipe sections can be individually manufactured, tested, and assembled into the complete serpentine configuration, while the bypass line network provides operational flexibility for optimizing treatment performance.

The bypass architecture of the present wastewater systems enables the adjustable control of air introduction rates, which directly affects the lineal feet and volume of each treatment zone within the biologically active conduits, as well as the dissolved oxygen concentration profiles that determine treatment effectiveness.

FIG. 6 shows a detailed side-sectional view of the internal structure and biological media distribution within first module 142, revealing the specific placement and arrangement of biological chips 208 and mesh separators 212 that create the distinct treatment zones within biologically active conduits. This view provides critical insight into how the serpentine flow path accommodates different types of biological media while maintaining zone segregation through strategic positioning of separators.

The cross-sectional perspective clearly illustrates the vertical stratification of treatment zones within the biologically active conduits, showing aerobic stage of treatment 214 positioned at or near the top portion, anoxic stage of treatment 216 disposed at or near the middle portion, and anaerobic stage of treatment 218 located at or near the bottom portion of the serpentine flow path. This vertical arrangement enables the oxygen gradient necessary for sequential biological treatment processes.

Biological chips 208, which function as carriers loaded with bacteria, are strategically disposed within specific linear portions of the biologically active conduits to populate each treatment zone with the appropriate dominant biologically active media. The distribution pattern shows aerobic biological chips containing aerobic dominant biologically active media disposed in aerobic stage of treatment 214, anoxic biological chips containing anoxic dominant biologically active media positioned in anoxic stage of treatment 216, and anaerobic biological chips containing anaerobic dominant biologically active media placed in anaerobic stage of treatment 218. Examples of aerobic dominant biologically active media include Pseudomonas Putida, examples of anoxic dominant biologically active media include Nitrosomonas and Nitrobacter and examples of anaerobic dominant biologically active media include Bacillus and Pseudomonas.

Mesh separators 212 are positioned at critical locations to serve as physical boundaries between the treatment zones, preventing displacement of biological chips 208 between aerobic, anoxic, and anaerobic stages while allowing wastewater and treated effluent to pass through freely. The mesh configuration ensures that each type of biological chip remains within its designated treatment zone during operation, maintaining the integrity of the sequential treatment process.

Twisted portions 215 of the biologically active conduit demonstrates areas that are substantially free of biological chips 208, corresponding to the twisted portions of the serpentine flow path that provide transitional flow paths between the linear portions containing the biological media. As explained above, these chip-free portions enable smooth wastewater flow transitions while preventing biological media displacement during operation.

First module overflow manifold 180 is shown positioned above the treatment zones to collect excess wastewater, with first module recirculation conduit 188 providing the pathway for treated wastewater to be recirculated back through first recirculation subassembly 174. The spatial relationship demonstrates how overflow management and recirculation systems integrate with the biological treatment zones without interfering with the biological media placement.

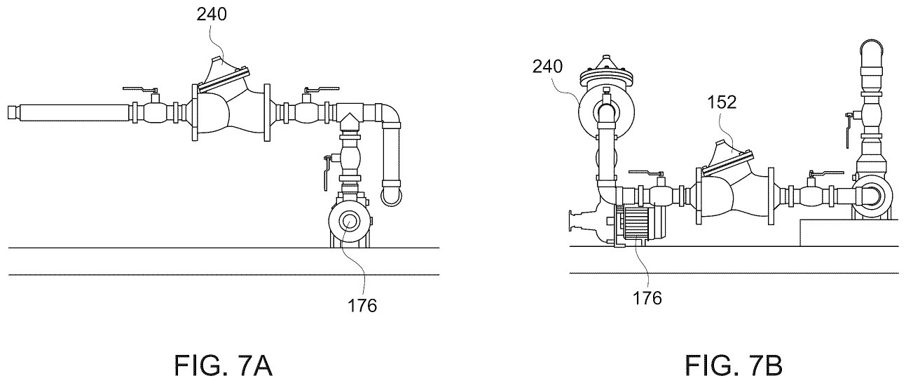

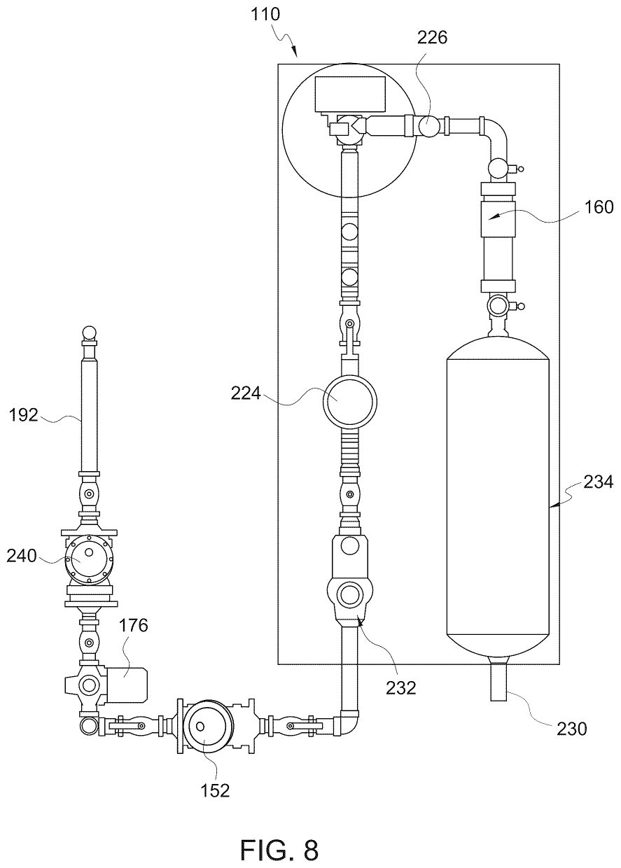

FIG. 7A shows a side view of an arrangement of an automatic recirculation valve and a discharge pump, according to one embodiment of the present arrangements, disposed after a biological treatment module (e.g., second module 144 shown in FIG. 2) and before the exemplar post treatment subassembly 110 shown in FIG. 2. This figure demonstrates the critical valve and pump configuration that enables selective flow control between recirculation and advancement modes of operation within the wastewater treatment system.

FIG. 7A specifically illustrates second module discharge pump 176 in its operational position relative to second recirculation automatic valve 240, revealing the mechanical arrangement that facilitates dual-mode operation of treated wastewater flow. The positioning of second module discharge pump 176 demonstrates how the pump creates the necessary pressure differential to drive treated wastewater either through the recirculation pathway back to the second module or forward to downstream treatment processes, depending on the operational state of second recirculation automatic valve 240.

Second recirculation automatic valve 240 is shown in a configuration that controls the direction of treated wastewater flow from second module discharge pump 176. When second recirculation automatic valve 240 is in an open position (and second automatic valve 152 shown in FIG. 2 is closed), treated wastewater flows through the recirculation pathway back to the second module for additional biological treatment cycles. The valve's automatic operation enables programmed control of recirculation cycles based on treatment requirements, water quality parameters, or predetermined time intervals.

FIG. 7B shows the same valve and pump arrangement as FIG. 7A but additionally reveals second automatic valve 152 disposed after the second module in the flow path. This expanded view demonstrates the complete valve configuration necessary for coordinated control of treated wastewater advancement from the second module to the post treatment subassembly.

The relationship between second recirculation automatic valve 240 and second automatic valve 152 creates a coordinated valve system where the operational states of both valves determine the flow path of treated wastewater. When second recirculation automatic valve 240 is in an open position and second automatic valve 152 is in a closed position, second module discharge pump 176 recirculates treated wastewater back to the second module. Conversely, when second recirculation automatic valve 240 is in a closed position and second automatic valve 152 is in an open position, second module discharge pump 176 advances treated wastewater, through second module post treatment conduit 164, to the post treatment subassembly (e.g. post treatment subassembly 110 shown in FIG. 2).

FIG. 7B illustrates how second automatic valve 152 serves as the primary control point for treated wastewater advancement from the second module to downstream treatment processes. The valve's positioning downstream from second module discharge pump 176 ensures that pump pressure is maintained regardless of whether wastewater is being recirculated or advanced, providing consistent flow control throughout the system.

The mechanical arrangement shown in both FIGS. 7A and 7B demonstrates the pump-valve integration that enables automated control of treatment intensity through selective recirculation. Second module discharge pump 176 operates continuously while the valve positions determine flow direction, eliminating the need for pump cycling and maintaining steady hydraulic conditions within the system.

The side view perspective of both FIGS. 7A and 7B reveals the compact spatial arrangement of these critical flow control components, showing how the valve and pump assembly integrates within the overall modular design without requiring excessive space allocation. This configuration enables precise control of residence time within the biological treatment zones by varying the number of recirculation cycles before wastewater advancement to final treatment stages.

The automatic operation of both second recirculation automatic valve 240 and second automatic valve 152 facilitates programmable control sequences that can optimize treatment effectiveness based on influent characteristics, desired effluent quality, or operational efficiency requirements. This valve coordination system represents a key advancement in automated wastewater treatment control that enables adaptive treatment strategies without manual intervention.

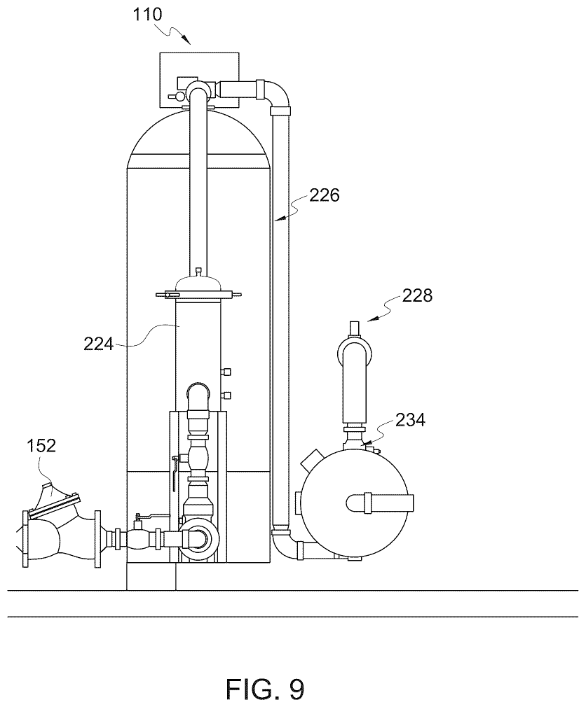

FIG. 8 shows a top view of a flow path, according to one embodiment of the present arrangements, extending from a recirculation inlet line associated with a biological treatment module (e.g., the second module 144 shown in FIG. 2) to and through the exemplar post treatment subassembly shown in FIG. 2. This figure demonstrates the complete flow pathway from the biological treatment system through the final polishing and disinfection stages.

FIG. 8 specifically illustrates the integration of second module discharge pump 176 with second recirculation automatic valve 240 and second automatic valve 152, showing how these components coordinate to direct treated wastewater either back to the second module for additional biological treatment cycles or forward to post treatment subassembly 110. Second module recirculation conduit 192 provides the fluid communication pathway that enables this dual-mode operation.

The post treatment train shown in FIG. 8 includes post treatment disc filter 224 positioned as the first stage of post-biological treatment, designed to remove suspended solids from the biologically treated wastewater. Downstream from post treatment disc filter 224, activated carbon bed 226 serves to remove organic compounds, contaminants, and specifically per- and polyfluoroalkyl substances (PFAS) from the filtered wastewater. UV disinfection module 160 is positioned downstream from activated carbon bed 226 to provide pathogen destruction through ultraviolet irradiation. A chlorine dosage tank 234 disposed downstream UV disinfection module 228 provides chemical disinfection of the treated wastewater to provide recycled water meeting high regulatory requirements for water quality. Although such a tank is not necessary to produce high quality recycled water, use of this tank represents a more preferred embodiment of the present arrangements.

Post treatment effluent pipe 230 conveys the fully treated wastewater from UV disinfection module 228, while post treatment discharge pump 232 provides the motive force necessary to move treated effluent through the post treatment subassembly and to final storage or discharge. The linear arrangement of these components in FIG. 8 demonstrates the sequential treatment approach employed in post treatment subassembly 110.

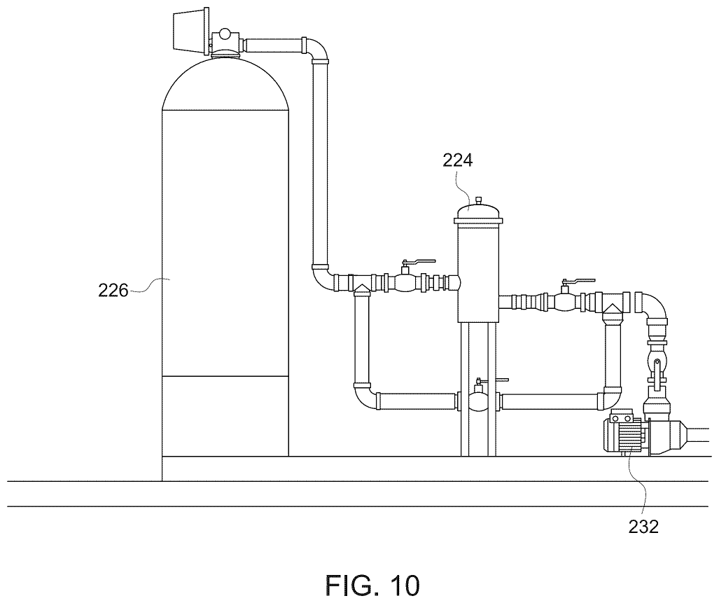

FIG. 9 shows a magnified side view of the exemplar post treatment subassembly shown in FIGS. 2 and 3 and includes a chlorine dosage tank. This perspective reveals the three-dimensional spatial relationships and vertical integration of the post treatment components.

FIG. 9 demonstrates the vertical configuration of post treatment subassembly 110, with post treatment disc filter 224 positioned at the base of the assembly to receive biologically treated wastewater from second automatic valve 152. The vertical orientation of activated carbon bed 226 is designed to provide adequate contact time for PFAS adsorption and organic compound removal.

A distinctive feature revealed in FIG. 9 is chlorine dosage tank 234, which provides chemical disinfection capability in addition to the UV disinfection shown in other figures. Chlorine dosage tank 234 is positioned to enable chlorine injection into the treatment stream, providing a dual disinfection approach that combines chemical and physical pathogen destruction methods. The tank's cylindrical configuration and piping connections demonstrate how chlorine solution can be precisely metered and injected into the treatment process.

UV disinfection module 228 is shown in its operational position relative to the other treatment components, with its horizontal orientation providing optimal flow characteristics for UV exposure. The side view perspective of FIG. 9 reveals the compact vertical integration achieved in post treatment subassembly 110, where multiple treatment functions are stacked to minimize the horizontal footprint while maintaining optimal treatment performance.

The integration of chlorine dosage tank 234 with the existing treatment train demonstrates the modular approach employed in the present arrangements, where additional treatment capabilities can be incorporated without requiring extensive system reconfiguration. This side view clearly shows how the post treatment subassembly achieves comprehensive water polishing through the sequential application of physical, chemical, and photochemical treatment processes within a compact, vertically integrated design.

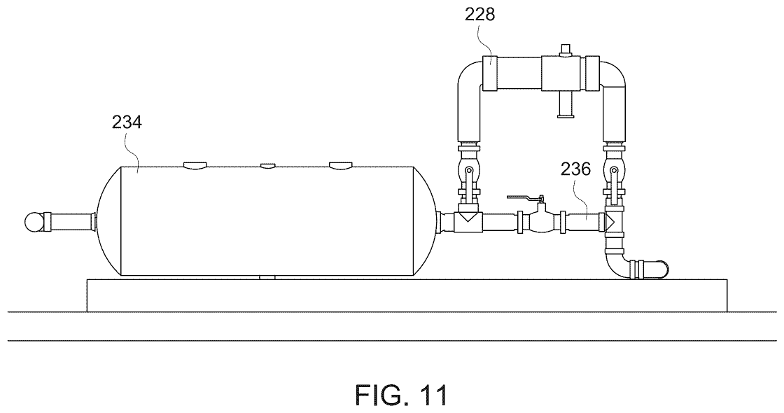

FIG. 10 shows an end view of the exemplar post treatment subassembly shown in FIGS. 2 and 3, revealing the internal structural configuration and dimensional relationships of the post-biological treatment components. This perspective demonstrates the vertical integration and compact arrangement of the sequential treatment stages within post treatment subassembly 110.

The end view clearly illustrates the vertical positioning of post treatment disc filter 224 at the base of the assembly, showing its cylindrical configuration and inlet/outlet connections designed to receive biologically treated wastewater from the second module. The substantial height and internal structure of activated carbon bed 226 is shown in this orientation, demonstrating the vertical column design that provides adequate contact time for PFAS adsorption and organic compound removal from the substantially suspended-solids-free wastewater.

Post treatment discharge pump 232 is shown in its operational position relative to the other treatment components. The end view perspective reveals how post treatment discharge pump 232 integrates with the vertical treatment train to provide the motive force necessary for advancing treated effluent through the sequential stages of disc filtration and carbon treatment.

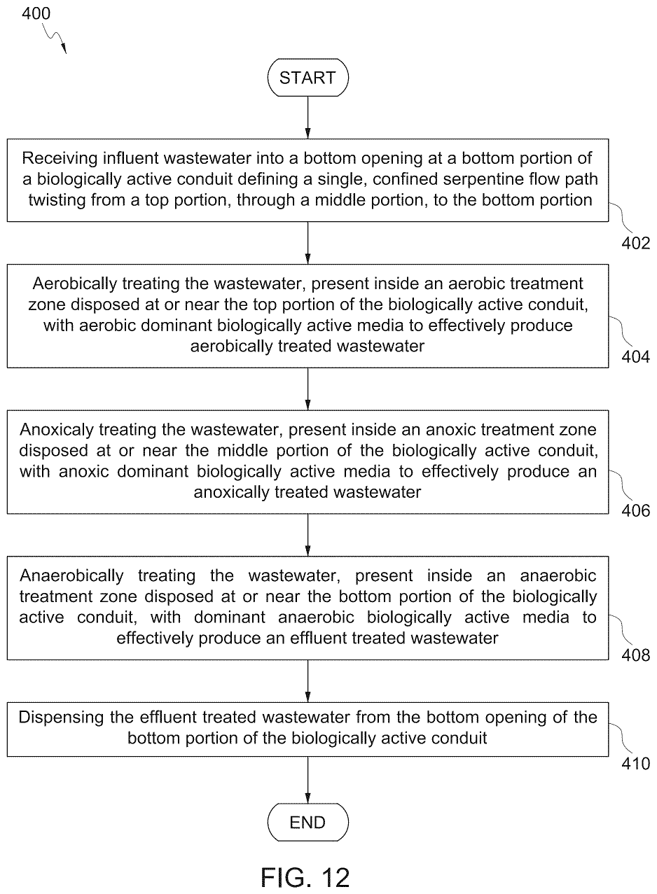

FIG. 11 shows another magnified end view of a present arrangement surrounding the chlorine dosage tank 234 shown in FIG. 9, according to one embodiment of the present arrangements, revealing the chemical injection system integration and bypass line configuration that enables dual disinfection approaches within the post treatment subassembly.

This figure specifically illustrates the positioning and piping connections of chlorine dosage tank 234 relative to UV disinfection module 228, demonstrating how chemical disinfection capability is integrated with the physical disinfection provided by ultraviolet irradiation. Chlorine dosage tank 234 is shown with its cylindrical storage configuration and metering connections that enable precise chlorine solution injection into the treatment stream.

A distinctive feature revealed in FIG. 11 is post treatment bypass line 236, which provides an alternative flow path that allows treated wastewater to circumvent certain treatment stages when operational conditions or treatment requirements dictate modified processing. Post treatment bypass line 236 demonstrates the operational flexibility built into the post treatment subassembly, enabling system optimization based on influent characteristics or desired effluent quality parameters.

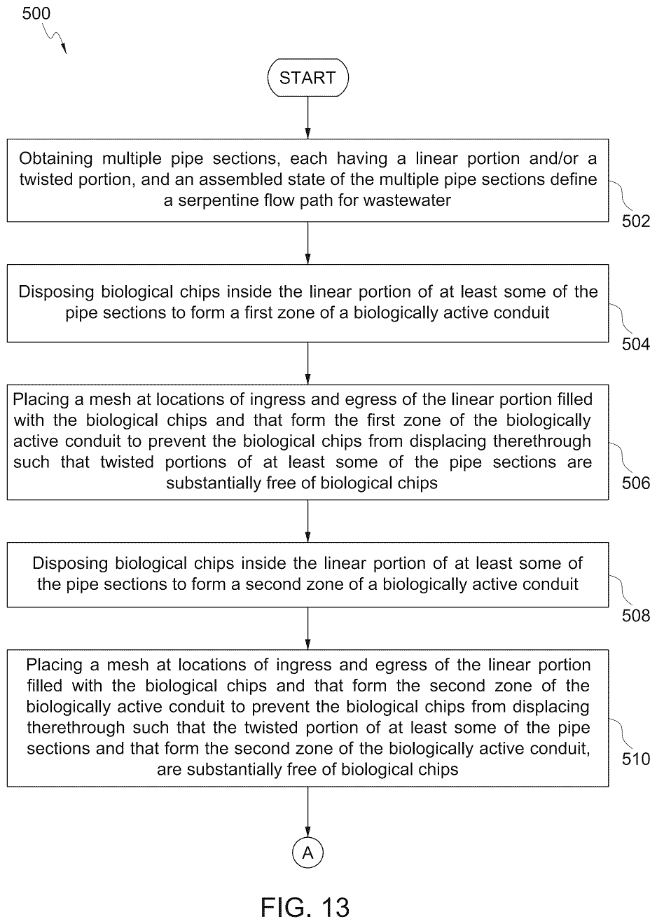

FIG. 12 shows a flow chart of a wastewater treatment method 400, according to preferred embodiments of the present teachings.

Wastewater treatment method 400 begins with a receiving element 402, which includes receiving influent wastewater into a bottom opening disposed at a bottom portion of a biologically active conduit defining a single, confined serpentine flow path twisting from a top portion, through a middle portion, to a bottom portion. By way of example, receiving element 402 utilizes the bottom openings shown in first module conduits 255a-255n of FIG. 2, which are connected to first module influent manifold outlets 254a-254n. In preferred embodiments of the present teachings, receiving element 402 includes the wastewater flowing through influent line 106 (shown in FIGS. 1-4) and being distributed through first module influent manifold 244 (shown in FIGS. 2 and 4) to the plurality of biologically active conduits within first module 142.

Wastewater treatment method 400 then proceeds to an aerobically treating element 404, which involves aerobically treating wastewater, present inside an aerobic treatment zone disposed at or near the top portion of the biologically active conduit, with aerobic dominant biologically active media to effectively produce aerobically treated wastewater. As another example, aerobically treating element 404 operates within aerobic stage of treatment 214 shown in FIG. 6, utilizing aerobic biological chips containing aerobic dominant biologically active media. In one embodiment of the present teachings, aerobically treating element 404 includes drawing air into the aerobic treatment zone using venturi 200 or 202 (shown in FIGS. 5A and 5B) disposed at or near the top portion of the biologically active conduit.

Wastewater treatment method 400 also includes an anoxically treating element 406. This element comprises anoxically treating the wastewater, present inside an anoxic treatment zone disposed at or near the middle portion of the biologically active conduit, with anoxic dominant biologically active media to effectively produce anoxically treated wastewater. By way of example, anoxically treating element 406 occurs within anoxic stage of treatment 216 shown in FIG. 6, where anoxic biological chips containing anoxic dominant biologically active media are disposed inside the linear portions of the serpentine flow path. In preferred embodiments of the present teachings, anoxically treating element 406 includes releasing air or gas collected inside the anoxic treatment zone to maintain an effective anoxic environment, as facilitated by the air/gas release passages described in connection with previous figures.

Wastewater treatment method 400 comprises an anaerobically treating element 408 which includes anaerobically treating the wastewater, present inside an anaerobic treatment zone disposed at or near the bottom portion of the biologically active conduit, with dominant anaerobic biologically active media to effectively produce an effluent treated wastewater. As another example, anaerobically treating element 408 takes place within anaerobic stage of treatment 218 shown in FIG. 6, utilizing anaerobic biological chips containing anaerobic dominant biologically active media positioned in the linear portions near the bottom of the serpentine flow path. In one embodiment of the present teachings, anaerobically treating element 408 operates in an environment with minimal oxygen content, positioned at the greatest distance from venturi 200 or 202 shown in FIGS. 5A and 5B.

After conclusion of biological treatment according to aerobically treating, anoxically treating, and anaerobically treating elements of 404, 406 and 408, wastewater treatment method 400 advances to a dispensing element 410. This element includes dispensing the effluent treated wastewater from the bottom opening of the bottom portion of the biologically active conduit. By way of example, dispensing element 410 utilizes the same bottom openings that were used in connection with receiving element 402 but now serves as outlets for the treated wastewater that has undergone sequential processing through all three treatment zones. In preferred embodiments of the present teachings, dispensing element 410 may direct the effluent treated wastewater either to recirculation systems such as first recirculation subassembly 174 (shown in FIGS. 3, 4, and 5A) for additional treatment cycles, or to downstream treatment modules such as second module 144 (shown in FIGS. 2 and 3) for further biological treatment.

In one embodiment of the present teachings, the entire sequence of elements 402, 404, 406, 408, and 410 may be repeated multiple times through recirculation before the treated wastewater advances to post treatment subassembly 110 (shown in FIGS. 2 and 3) for final polishing. As another example, the wastewater treatment method 400 may be implemented simultaneously across multiple biologically active conduits within a single module, such as the plurality of conduits 255a-255n shown in first module 142 of FIGS. 2 and 4, thereby increasing the overall treatment capacity of the wastewater treatment system. As yet another example, aerobically treating, anoxically treating, and anaerobically treating elements of 404, 406 and 408 are carried out batchwise and simultaneously.

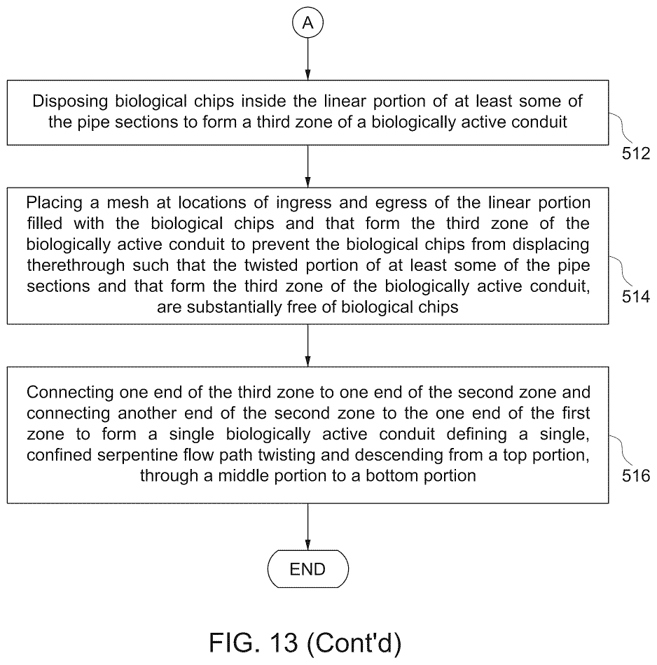

FIG. 13 shows a flow chart of a method for assembling a biological treatment module 500, according to preferred embodiments of the present teachings, which implements the structural arrangements described in connection with the biologically active conduits shown in FIGS. 2-6.

The method for assembling 500 provides a systematic approach for constructing the biological treatment modules such as first module 142 and second module 144 shown in FIGS. 2 and 3, ensuring proper segregation of treatment zones while maintaining the serpentine flow path configuration.

The method for assembling 500, according to one embodiment of the present teachings, comprises an obtaining element 502, which includes obtainig multiple pipe sections, each having a linear portion and/or a twisted portion. An assembled state of the multiple pipe sections defines a serpentine flow path for wastewater. By way of example, obtaining element 502 utilizes pipe sections that, when assembled, form the biologically active conduits 255a-255n shown in first module 142 of FIGS. 2 and 4, or biologically active conduits 355a-355n shown in second module 144 of FIG. 2. In one embodiment of the present teachings, obtaining element 502 includes pipe sections that will ultimately create the single, confined serpentine flow path twisting from a top portion, through a middle portion, to a bottom portion as illustrated in the cross-sectional view of FIG. 6.

The method for assembling 500 then proceeds to a first disposing element 504, which involves disposing biological chips 208 inside the linear portion of at least some of the pipe sections to form a first zone of a biologically active conduit. As another example, first disposing element 504 utilizes biological chips 208 as shown in FIG. 6, which function as carriers loaded with bacteria and are strategically positioned within specific linear portions of the pipe sections. In preferred embodiments of the present teachings, first disposing element 504 creates one of the treatment zones such as aerobic stage of treatment 214, anoxic stage of treatment 216, or anaerobic stage of treatment 218 shown in FIG. 6.

Then method for assembling 500 advances to a first placing element 506. In this element, a mesh is placed at locations of ingress and egress of the linear portions filled with the biological chips and that form the first zone of the biologically active conduit. First placing element 506 prevents biological chips 208 from displacing through the linear portion. In this configuration, twisted portions of at least some of the pipe sections are substantially free of biological chips. By way of example, first placing element 506 utilizes mesh separators such as mesh 212 shown in FIGS. 5A and 6, which serve as physical boundaries between treatment zones. In one embodiment of the present teachings, first placing element 506 ensures that twisted portion 215 of the biologically active conduit shown in FIG. 6 remains substantially free of biological chips 208, corresponding to the twisted portions that provide transitional flow paths.

The method for assembling 500 then carries out a second disposing element 508, which involves disposing biological chips 208 inside the linear portion of at least some of the pipe sections to form a second zone of a biologically active conduit. As another example, second disposing element 508 creates an additional treatment zone distinct from the first zone created in first disposing element 504, utilizing the same type of biological chips 208 shown in FIG. 6 but containing different dominant biologically active media appropriate for the specific treatment zone being formed.

Next, method for assembling 500 advances to a second placing element 510. In this element, a mesh is placed at locations of ingress and egress of the linear portion filled with the biological chips and that form the first zone of the biologically active conduit. The mesh prevents the biological chips from displacing through the linear portions and the twisted portion of at least some of the pipe sections, that form the second zone of the biologically active conduit, are substantially free of biological chips. In preferred embodiments of the present teachings, second placing element 510 utilizes additional mesh separators similar to those shown as mesh 212 in FIGS. 5A and 6, maintaining the segregation between the first zone and second zone.

The method for assembling 500 then carries out a third disposing element 512, which involves disposing biological chips 208 inside the linear portion of at least some of the pipe sections to form a third zone of a biologically active conduit. By way of example, third disposing element 512 completes the creation of the three-zone system comprising aerobic stage of treatment 214, anoxic stage of treatment 216, and anaerobic stage of treatment 218 as shown in FIG. 6, where each zone contains biological chips 208 with different dominant biologically active media.

Then method for assembling 500 proceeds to a third placing element 514, which includes placing a mesh at locations of ingress and egress of the linear portion filled with the biological chips and that form the third zone of the biologically active conduit to prevent the biological chips from displacing therethrough and that the twisted portion of at least some of the pipe sections and that form the third zone of the biologically active conduit, are substantially free of biological chips. As another example, third placing element 514 utilizes mesh separators equivalent to those shown as mesh 212 in FIG. 6, ensuring complete segregation of all three treatment zones within the assembled biologically active conduit.

Method for assembling 500 carries out a connecting element 516, which includes connecting one end of the third zone to one end of the second zone and connecting another end of the second zone to the one end of the first zone to form a single biologically active conduit defining a single, confined serpentine flow path twisting from a top portion, through a middle portion to a bottom portion. In one embodiment of the present teachings, connecting element 516 creates the serpentine flow configuration visible in the biologically active conduits 255a-255n of first module 142 shown in FIGS. 4 and 5A, or the equivalent configuration in biologically active conduits 355a-355n of second module 144 shown in FIG. 2. In preferred embodiments of the present teachings, connecting element 516 results in a completed biologically active conduit that can be supported on first rack 175 shown in FIGS. 4, 5A, and 6, forming part of a module such as first module 142 or second module 144 shown in FIGS. 2 and 3.

By way of example, the completed assembly from method for assembly 500 may be integrated with the recirculation subassemblies such as first recirculation subassembly 174 shown in FIGS. 3, 4, and 5A, the overflow subassembly 146 shown in FIGS. 2, 3, and 4, and the influent manifold systems such as first module influent manifold 244 shown in FIGS. 2 and 4, to create a fully functional biological treatment module capable of simultaneous aerobic, anoxic, and anaerobic wastewater treatment as described in connection with the previous figures.

The present teachings also provide methods of managing an attribute of wastewater treatment. The methods, according to one embodiment of the present teachings, comprise obtaining a system for managing the attribute of wastewater treatment carried out inside a set of biologically active conduits. The system for managing the attribute of wastewater treatment comprise a recirculation inlet line designed to deliver treated wastewater. By way of example, the recirculation inlet line may be configured as first module recirculation conduit 188 shown in FIGS. 3, 4, and 5A, which couples to first manifold 190 of first module 142. The system further includes a manifold line in fluid communication with the recirculation inlet line and designed to dispense the treated wastewater received from the recirculation inlet line, wherein as another example, the manifold line may be implemented as first manifold line 197 shown in FIG. 5A, which provides fluid communication between the recirculation system and first manifold 190.

The system for managing the attribute of wastewater treatment also comprise a venturi line connected at a venturi inlet end to the recirculation inlet line and connected at a venturi outlet end to the manifold line, wherein in one embodiment of the present teachings, the venturi line may be configured as first venturi line 274 shown in FIG. 5B, which connects first venturi 200 at the venturi inlet end to first manifold line 197 and at the venturi outlet end to first manifold line 197. Additionally, the system for managing the attribute of wastewater treatment includes a bypass line connected at a bypass inlet end to the recirculation inlet line and connected at a bypass outlet end to the manifold line. The bypass inlet end and the bypass outlet end are separated a separating distance from the venturi inlet end and the venturi outlet, respectively, such that the bypass line represents a bypass flow path to the venturi line. By way of example, the bypass line may be implemented as first bypass line 272 shown in FIG. 5B, which is associated with first recirculation subassembly 174 and provides a bypass flow path that allows treated wastewater to circumvent first venturi 200.

The system for managing the attribute of wastewater treatment further comprises a venturi disposed on the venturi line and designed to draw in and advance air towards the venturi outlet and the manifold line, wherein as another example, the venturi may be configured as first venturi 200 shown in FIGS. 5A and 5B, which is associated with first manifold 190 and provides independent air introduction capabilities. An adjustable bypass valve is disposed on the bypass line and is capable of acquiring different settings and thereby capable of regulating flow, through the bypass line, of the treated wastewater that enters the manifold line and/or regulating flow, through the venturi and the venturi line, of the treated wastewater mixed with the air that enters the manifold line. In preferred embodiments of the present teachings, the adjustable bypass valve may be implemented as first bypass valve 204 shown in FIGS. 5A and 5B, which functions in conjunction with first manifold 190 to regulate the proportion of recirculated wastewater that bypasses first venturi 200.

The system for managing the attribute of wastewater treatment includes a manifold coupled to the manifold line and capable of receiving and dispersing the treated wastewater and/or air received from the manifold line. By way of example, the manifold may be configured as first manifold 190 shown in FIGS. 3, 5A, and 5B, which is part of first recirculation subassembly 174 for recirculation in first module 142. A set of plurality of extending outlets protrude from the manifold and are capable of dispensing the treated wastewater and/or air dispersed inside the manifold, wherein as another example, the plurality of extending outlets may be implemented as the plurality of recirculation manifold outlets designed to convey the treated wastewater to plurality of top inlets of plurality of the biologically active conduits as described in connection with the recirculation subassembly. The system for managing the attribute of wastewater treatment also comprises a set of plurality of biologically active conduits, each of which connect to one of the extending outlets. In one embodiment of the present teachings, the plurality of biologically active conduits may be configured as biologically active conduits 255a, 255b, 255c shown in FIGS. 5A and 6, each defining a single, confined serpentine flow path that twists and descends from a top portion, through a middle portion, to a bottom portion.

Once the system for managing the attribute of wastewater treatment is obtained, the methods of managing an attribute of wastewater treatment proceeds to adjusting settings of the adjustable bypass valve to allow changing flowrates of treated wastewater inside the bypass line and/or the venturi line. Based upon the adjusting of settings of the adjustable bypass valve, changes the flowrate of wastewater inside the bypass line, enabling precise control of the air-to-wastewater ratio entering the manifold. The adjusting also enables drawing in varying amounts of air, using the venturi, into the manifold and dispersing the varying amounts of air in the treated wastewater present inside the manifold and creating different mixtures of treated wastewater and air. By way of example, the independent bypass control provided by the adjustable bypass valve allows for sophisticated management of dissolved oxygen profiles within different regions of the plurality of biologically active conduits. The method includes contemporaneously dispensing, through the set of plurality of extending outlets into the plurality of biologically active conduits, a regulated flowrate of the different mixtures of treated wastewater and air to form, inside the plurality of biologically active conduits, a desirable attribute of wastewater treatment.

The desirable attribute is one member chosen from a group comprising average lineal feet of the plurality of biologically active conduits that form an aerobic zone, average lineal feet of the plurality of biologically active conduits that form an anoxic zone, average lineal feet of the plurality of biologically active conduits that form an anaerobic zone, average volume of the plurality of biologically active conduits that form the aerobic zone, average volume of the plurality of biologically active conduits that form the anoxic zone, average volume of the plurality of biologically active conduits that form the anaerobic zone, dissolved oxygen concentration profile inside each of the biologically active conduits, average dissolved oxygen concentration profile inside the plurality of biologically active conduits and pressure differential across the venturi.

The present methods of managing an attribute of wastewater treatment provide significant operational advantages over conventional biological treatment systems. The adjustable bypass valve configuration enables fine-tuning of dissolved oxygen profiles within the treatment zones, allowing for optimization of bacterial activity in aerobic stage of treatment 214, anoxic stage of treatment 216, and anaerobic stage of treatment 218 as shown in FIG. 6. This precise control capability enables adaptive treatment strategies that can respond to varying influent characteristics while maintaining optimal treatment efficiency within the compact modular design.

In the adjusting settings element of the present teachings, when the adjustable bypass valve is completely open, the drawing includes drawing into the manifold a small or a negligible amount of air, realizing inside the plurality of the biologically active conduits a completely-open-bypass-valve attribute value.

The completely-open-bypass-valve attribute is one member chosen from a group comprising minimum average lineal feet of the plurality of biologically active conduits that form the aerobic zone, minimum average lineal feet of the plurality of biologically active conduits that form the anoxic zone, maximum average lineal feet of the plurality of biologically active conduits that form the anaerobic zone, minimum average volume of the plurality of biologically active conduits that form the aerobic zone, minimum average volume of the plurality of biologically active conduits that form the anoxic zone, maximum average volume of the plurality of biologically active conduits that form the anaerobic zone, minimum average dissolved oxygen concentration profile inside the biologically active conduits that form the aerobic zone and the anoxic zone, maximum average dissolved oxygen concentration profile inside the biologically active conduits that form the anaerobic zone and pressure differential across the venturi.

By way of example, when first bypass valve 204 shown in FIGS. 5A and 5B is completely open, a maximum amount of recirculated wastewater bypasses first venturi 200, resulting in minimal air entrainment and creating predominantly anaerobic conditions throughout most of the serpentine flow path. In one embodiment of the present teachings, this configuration also maximizes the effective volume available for anaerobic biological chips containing anaerobic dominant biologically active media as shown in FIG. 6. Moreover, the pressure differential across first venturi 200 shown in FIGS. 5A and 5B is minimized when the bypass valve is completely open, reducing energy consumption while maintaining effective anaerobic treatment.

The completely-open-bypass-valve configuration provides optimal conditions for anaerobic treatment processes, maximizing the effective treatment volume for anaerobic biological chips. This configuration is particularly advantageous for treating high-strength organic wastewater where extensive anaerobic digestion is required, while minimizing energy consumption through reduced venturi operation.

In the adjusting settings element of the present teachings, when the adjustable bypass valve is partially open to an intermediate extent of bypass valve capacity, the drawing includes drawing into the manifold an intermediate amount of air, realizing inside the plurality of the biologically active conduits a partially-open-bypass-valve attribute value. The partially-open-bypass-valve attribute is one member chosen from a group comprising intermediate average lineal feet of the plurality of biologically active conduits that form the aerobic zone, intermediate average lineal feet of the plurality of biologically active conduits that form the anoxic zone, intermediate average lineal feet of the plurality of biologically active conduits that form the anaerobic zone, intermediate average volume of the plurality of biologically active conduits that form the aerobic zone, intermediate average volume of the plurality of biologically active conduits that form the anoxic zone, intermediate average volume of the plurality of biologically active conduits that form the anaerobic zone, intermediate average dissolved oxygen concentration profile inside the biologically active conduits that form the aerobic zone, the anoxic zone, and the anaerobic zone and pressure differential across the venturi.

By way of example, when first bypass valve 204 shown in FIGS. 5A and 5B is partially open, a controlled amount of air is drawn through first venturi 200, creating a balanced distribution of treatment zones within the serpentine flow path. As another example, the partially open configuration enables the formation of distinct anoxic stage of treatment 216 as shown in FIG. 6, providing optimal conditions for anoxic biological chips containing anoxic dominant biologically active media. As yet another example, this configuration creates a graduated oxygen profile that enables simultaneous aerobic, anoxic, and anaerobic treatment processes as illustrated by the three treatment zones in FIG. 6 and the intermediate pressure differential across first venturi 200 shown in FIGS. 5A and 5B provides optimal energy efficiency while maintaining effective treatment performance across all three biological treatment zones.

In the adjusting settings element of the present teachings, when the adjustable bypass valve is completely closed, the drawing includes drawing into the manifold a maximum amount of air, realizing inside the plurality of the biologically active conduits a completely-closed-bypass-valve attribute value. The completely-closed-bypass-valve attribute is one member chosen from a group comprising maximum average lineal feet of the plurality of biologically active conduits that form the aerobic zone, maximum average lineal feet of the plurality of biologically active conduits that form the anoxic zone, minimum average lineal feet of the plurality of biologically active conduits that form the anaerobic zone, maximum average volume of the plurality of biologically active conduits that form the aerobic zone, maximum average volume of the plurality of biologically active conduits that form the anoxic zone, minimum average volume of the plurality of biologically active conduits that form the anaerobic zone, maximum average dissolved oxygen concentration profile inside the biologically active conduits that form the aerobic zone and the anoxic zone, and minimum average dissolved oxygen concentration profile inside the biologically active conduits that form the anaerobic zone and pressure differential across the venturi.

By way of example, when first bypass valve 204 shown in FIGS. 5A and 5B is completely closed, all recirculated wastewater passes through first venturi 200, drawing maximum air and creating extensive aerobic stage of treatment 214 as shown in FIG. 6. In one embodiment of the present teachings, the maximum air introduction limits the effective anaerobic treatment volume to the bottom portion of the serpentine flow path where anaerobic biological chips are positioned as shown in FIG. 6. Additionally, the maximum air introduction through first venturi 200 shown in FIGS. 5A and 5B creates optimal conditions for aerobic bacteria to carry out at least one type of aerobic treatment chosen from digesting organic material, reducing chemical oxygen demand (“COD”), reducing biochemical oxygen demand (“BOD”), reducing ammonia to produce nitrite compounds, and reducing nitrite compounds to produce nitrate compounds. Moreover, the maximum pressure differential across first venturi 200 creates optimal air entrainment for aerobic treatment processes while providing effective mixing of treated wastewater and air.

The completely-closed-bypass-valve configuration maximizes aerobic treatment capacity, making it particularly advantageous for treating wastewater with high organic loads or elevated ammonia concentrations. This configuration optimizes the performance of aerobic biological chips, enabling efficient removal of organic compounds and nitrification processes while maintaining the sequential treatment approach through the serpentine flow path.

According to one preferred embodiment of the present teachings, the methods of managing the attribute of wastewater treatment includes an obtaining element, which involves obtaining a discharge pump and the plurality of biologically active conduits for a biological treatment module. The preferred method of managing the attribute of wastewater treatment further comprises a recirculating element, which involves recirculating, using the discharge pump, treated wastewater from the module, through multiple the recirculation inlet lines, multiple the manifold lines, multiple the bypass lines, multiple the bypass valves, multiple the venturi lines, multiple the venturis, multiple the manifolds and multiple the set of plurality of extending outlets, back to the plurality of conduits that are part of the module. Each of the biologically active conduits is directly connected to one of the extending outlets, and indirectly connected to one of the manifolds, one of the venturis, one of the venturi lines, one of the bypass valves, one of the bypass lines and one of the recirculation inlet lines.

By way of example, the discharge pump may be configured as first module discharge pump 168 shown in FIGS. 2, 3, and 4, which provides motive force for moving treated effluent from first module 142 and enables both recirculation within first module 142 and advancement of treated wastewater to downstream treatment processes. As another example, the multiple recirculation inlet lines may be implemented through the dual recirculation system comprising first recirculation subassembly 174 and second recirculation assembly 195 shown in FIG. 5A, both serving first module 142, which provides enhanced control over treatment parameters by enabling independent management of different portions of the module.

In one embodiment of the present teachings, the multiple manifolds may be configured as first manifold 190 and second manifold 196 shown in FIGS. 5A and 5B, which operate in parallel to provide independent pathway for recirculation control and sophisticated management of dissolved oxygen profiles within different regions of the plurality of biologically active conduits. In preferred embodiments of the present teachings, the multiple venturis may be implemented as first venturi 200 and second venturi 202 shown in FIGS. 5A and 5B, which provide independent air introduction capabilities, allowing for differential oxygenation control between different portions of the module or different treatment phases.

By way of example, the multiple bypass valves may be configured as first bypass valve 204 and second bypass valve 206 shown in FIGS. 5A and 5B, which enable independent bypass control and allow for sophisticated management of dissolved oxygen profiles within different regions of first module 142. As another example, the plurality of biologically active conduits may be implemented as biologically active conduits 255a, 255b, 255c . . . 255n shown in first module 142 of FIGS. 4, 5A, and 6, each defining a single, confined serpentine flow path and configured to receive wastewater through respective bottom openings connected to first module influent manifold outlets 254a, 254b, 254c shown in FIG. 4.

The integration of discharge pump operation with the multiple recirculation system architecture enables sophisticated control over treatment residence time and intensity. The dual recirculation system shown in FIG. 5A provides operational flexibility that allows first module 142 to be optimized for different influent characteristics while maintaining the compact modular form factor. This approach significantly enhances treatment efficiency compared to conventional single-pass biological treatment systems.

In one embodiment of the present methods of managing the attribute of wastewater treatment, the recirculating element is carried out to coarsely control the attribute value of wastewater treatment inside the plurality of biologically active conduits of the module, and the adjusting settings element is carried out to finely control the attribute value of wastewater treatment inside the plurality of biologically active conduits of the module. By way of example, the coarse control through the recirculating using first module discharge pump 168 shown in FIGS. 2, 3, and 4 creates a pressure differential across the venturi system that affects the overall amount of air drawn by the venturis and mixed with the treated wastewater, thereby impacting the attribute values of wastewater treatment carried out inside the plurality of biologically active conduits.

As another example, the fine control through the adjusting settings of first bypass valve 204 and second bypass valve 206 shown in FIGS. 5A and 5B enables precise regulation of air-to-wastewater ratios entering first manifold 190 and second manifold 196, respectively, allowing for detailed optimization of treatment zone characteristics. In one embodiment of the present teachings, the discharge pump serves as a coarse controller regulating, in a coarse manner, the attribute of wastewater treatment carried out inside the plurality of biologically active conduits of the module, while the adjustable bypass valves serve as fine controllers regulating, in a fine manner, the attribute of wastewater treatment.

In preferred embodiments of the present teachings, the combination of coarse and fine control enables at least a set of biologically active conduits within the plurality of biologically active conduits of the module to carry out wastewater treatment under substantially the same attribute value, while allowing for differential control between different sets of conduits within the same module. By way of example, this dual-level control approach provides operational advantages by enabling rapid system-wide adjustments through discharge pump operation while maintaining precise zone-specific optimization through individual bypass valve control, resulting in superior treatment performance compared to conventional single-control biological treatment systems.

The dual-level control strategy combining coarse discharge pump control with fine bypass valve control provides unprecedented operational flexibility in biological wastewater treatment. This approach enables real-time optimization of treatment performance while maintaining system stability, allowing operators to respond quickly to changing influent conditions while fine-tuning individual treatment zones for optimal bacterial activity across aerobic stage of treatment 214, anoxic stage of treatment 216, and anaerobic stage of treatment 218 shown in FIG. 6.

In one embodiment of the present teachings, the methods of managing an attribute of wastewater treatment begin with an obtaining element, which involves obtaining a system for managing the attribute of wastewater treatment inside a biologically active conduit.

The system for managing the attribute of wastewater treatment comprises a system that includes the components/features shown in FIGS. 2, 3, 4 and 5A including a discharge pump.

The methods of managing an attribute of wastewater treatment include adjusting a pumping rate element, which involves adjusting the pumping rate of the discharge pump to create varying pressure differentials across the venturi system, followed by receiving inside the venturi line varying flow rates of treated wastewater. The methods of managing an attribute of wastewater treatment further comprise a drawing element, which includes drawing in varying amounts of air, using the venturi, into the manifold and dispersing the air mixed with the treated wastewater present inside the manifold to create a mixture of treated wastewater and air. In this element, the amount of air drawn is directly related to the pressure differential created by the discharge pump operation. The methods of managing an attribute of wastewater treatment also includes contemporaneously dispensing, through the set of plurality of extending outlets into the plurality of biologically active conduits, varying flowrates of the mixture of treated wastewater and air to realize varying attribute values of wastewater treatment inside the plurality of biologically active conduits of the module.

By way of example, when first module discharge pump 168 operates at higher pumping rates, increased pressure differential across first venturi 200 shown in FIGS. 5A and 5B results in greater air entrainment, creating more extensive aerobic stage of treatment 214 shown in FIG. 6. As another example, when the discharge pump operates at lower pumping rates, reduced pressure differential results in decreased air entrainment, allowing for more extensive anaerobic stage of treatment 218 shown in FIG. 6. In preferred embodiments of the present teachings, this pumping rate control enables dynamic adjustment of the relative volumes of aerobic, anoxic, and anaerobic treatment zones within the serpentine flow path without requiring physical modifications to the biologically active conduits.

The discharge pump rate control method provides a simplified yet effective approach to managing treatment zone attributes without requiring complex valve adjustments. This method enables rapid response to changing treatment requirements while maintaining operational simplicity, making it particularly suitable for automated treatment systems where minimal operator intervention is desired.

The methods of managing an attribute of wastewater treatment further comprise, during the adjusting the pumping rate of the discharge pump, holding constant an opening of a bypass valve disposed on a bypass line that provides an alternative flow path around the venturi. By way of example, when first bypass valve 204 shown in FIGS. 5A and 5B is maintained at a constant opening while first module discharge pump 168 shown in FIGS. 2, 3, and 4 varies its pumping rate, the bypass valve serves as a flow stabilizer that prevents extreme fluctuations in treatment zone characteristics.

As another example, holding constant the opening of the bypass valve ensures that the relationship between discharge pump rate and air entrainment remains predictable and linear, enabling more precise control over the attribute values of wastewater treatment. In one embodiment of the present teachings, the constant bypass valve opening provides a baseline flow path through first bypass line 272 shown in FIG. 5B, while variations in discharge pump rate primarily affect the flow through first venturi line 274, creating controlled changes in air introduction.

In preferred embodiments of the present teachings, this operational approach allows for systematic optimization of treatment performance by isolating the effects of discharge pump rate changes from bypass valve position changes, enabling operators to establish optimal baseline conditions before making fine adjustments. By way of example, maintaining constant bypass valve opening during discharge pump rate adjustments prevents conflicting control inputs that could destabilize the treatment process, particularly important when treating variable influent loads. As another example, this method enables the establishment of repeatable operating protocols where discharge pump rate can be adjusted predictably to respond to changing treatment requirements while maintaining stable baseline hydraulic conditions through the constant bypass valve setting.

The combination of variable discharge pump control with constant bypass valve operation provides operational stability while enabling responsive treatment optimization. This approach prevents system instability that could result from simultaneous adjustment of multiple control parameters, while ensuring that treatment zone modifications remain predictable and reversible. The method is particularly advantageous for automated control systems where consistent, repeatable responses to changing conditions are essential for maintaining treatment performance.

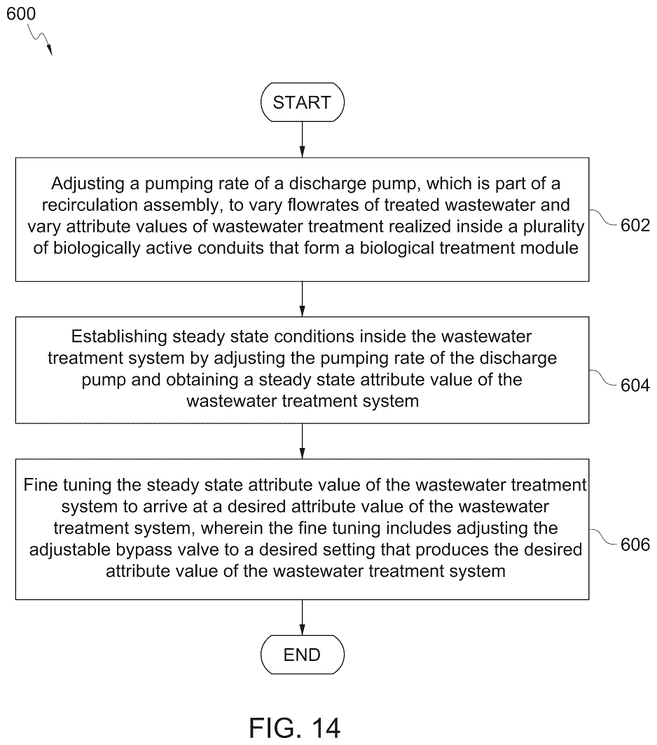

FIG. 14 shows a flowchart of methods for managing an attribute of a wastewater treatment 600, according to one embodiment of the present teachings, demonstrating the comprehensive control methodology that enables precise optimization of treatment zone characteristics within the biologically active conduits described in connection with previous figures.

The methods of managing the attribute of wastewater treatment 600 provide a hierarchical control approach that combines coarse control through discharge pump operation with fine control through adjustable bypass valve manipulation to achieve desired treatment zone attributes within the plurality of biologically active conduits such as those shown in first module 142 and second module 144 of FIGS. 2 and 3.

The methods of managing the attribute of wastewater treatment 600 comprise an adjusting element 602, which involves adjusting a pumping rate of a discharge pump, which is part of a recirculation assembly, to vary flowrates of treated wastewater and vary attribute values of wastewater treatment realized inside a plurality of biologically active conduits that form a biological treatment module. By way of example, adjusting element 602 utilizes discharge pumps such as first module discharge pump 168 and second module discharge pump 176 shown in FIGS. 2, 3, and 7A-7B, operating in conjunction with recirculation subassemblies such as first recirculation subassembly 174 and second recirculation assembly 195 shown in FIGS. 3, 5A, and 5B. In preferred embodiments of the present teachings, adjusting element 602 establishes changing hydraulic conditions that create varying pressure differentials across venturi lines such as first venturi line 274 and the venturi arrangements shown in FIG. 5B, thereby enabling different air entrainment rates that influence dissolved oxygen concentration profiles within the treatment zones.

The methods of managing the attribute of wastewater treatment 600 then proceed to an establishing element 604, which includes establishing steady state conditions inside the wastewater treatment system by adjusting the pumping rate of the discharge pump and obtaining a steady state attribute value of the wastewater treatment system. By way of example, establishing element 604 operates through iterative adjustment of pumping rates to achieve hydraulic equilibrium within the serpentine flow paths of biologically active conduits 255a-255n and 355a-355n shown in FIGS. 2 and 4, while monitoring system responses through the recirculation pathways including first module recirculation conduit 188 and second module recirculation conduit 192 shown in FIGS. 3 and 8. In one embodiment of the present teachings, establishing element 604 creates stable baseline conditions where the pressure differential across venturis such as first venturi 200 and second venturi 202 shown in FIGS. 5A and 5B reaches equilibrium, resulting in consistent air entrainment rates that define the steady state attribute values for average lineal feet of aerobic, anoxic, and anaerobic treatment zones within the biologically active conduits.

Once steady state conditions are established by carrying out establishing element 604, methods of managing the attribute of wastewater treatment 600 advance to a fine-tuning element 606. This element includes fine tuning the steady state attribute value of the wastewater treatment system to arrive at a desired attribute value of the wastewater treatment system. The fine tuning, preferably, includes adjusting the adjustable bypass valve to a desired setting that produces the desired attribute value of the wastewater treatment system. By way of example, fine-tuning element 606 utilizes adjustable bypass valves such as first bypass valve 204 and second bypass valve 206 shown in FIGS. 5A and 5B to regulate flow distribution between bypass lines such as first bypass line 272 and second bypass line 275 shown in FIG. 5B and their corresponding venturi lines. In preferred embodiments of the present teachings, fine tuning element 606 enables precise control of air-to-wastewater ratios entering manifolds such as first manifold 190 and second manifold 196 shown in FIGS. 3, 5A, and 5B, thereby allowing optimization of dissolved oxygen concentration profiles and the resulting average lineal feet and average volume of aerobic treatment zones such as aerobic stage of treatment 214, anoxic treatment zones such as anoxic stage of treatment 216, and anaerobic treatment zones such as anaerobic stage of treatment 218 shown in FIG. 6.

In one embodiment of the present teachings, methods of managing the attribute of wastewater treatment 600 may be implemented through automated control systems that monitor treatment performance and execute the adjusting, establishing, and fine-tuning elements to maintain optimal attribute values for the specific wastewater treatment objectives of the present wastewater treatment systems comprising modules such as first module 142 and/or second module 144 shown in FIGS. 2 and 3. As another example, the completed execution of method 600 enables dynamic optimization of treatment attributes while the wastewater treatment system operates, allowing real-time adjustment of treatment zone characteristics to accommodate varying influent conditions or desired effluent quality parameters without interrupting the continuous biological treatment processes occurring within the aerobic, anoxic, and anaerobic treatment zones of the biologically active conduits.

The present teachings provide wastewater treatment systems for removing PFAS from wastewater. One exemplar of such wastewater treatment systems comprises a biological treatment module including a biologically active conduit defining a serpentine flow path with sequential aerobic, anoxic, and anaerobic treatment zones. By way of example, the biological treatment module may be configured as first module 142 or second module 144 shown in FIGS. 2 and 3, comprising biologically active conduits 255a-255n or 355a-355n respectively, each defining the single, confined serpentine flow path described in connection with previous figures.

The biological treatment module reduces dissolved organic matter that competes with PFAS for adsorption sites and biotransforms PFAS precursor compounds. The biological treatment module includes aerobic stage of treatment 214, anoxic stage of treatment 216, and anaerobic stage of treatment 218 as shown in FIG. 6, populated with biological chips 208 containing zone-specific biologically active media.

The wastewater treatment systems for removing PFAS from wastewater further comprise disc filter subassembly 224 shown in FIGS. 8-10, disposed downstream from the biological treatment module and designed to remove suspended solids to produce substantially suspended-solids-free wastewater.

The wastewater treatment systems for removing PFAS from wastewater further still comprise a carbon treating subassembly disposed downstream from the disc filter subassembly. The carbon treating subassembly includes granular activated carbon (GAC) designed to adsorb PFAS compounds from the substantially suspended-solids-free wastewater to produce PFAS-reduced wastewater. In this configuration the biological treatment module enhances performance of the carbon treating subassembly by reducing organic matter competition and extending GAC operational life

By way of example, activated carbon bed 226 shown in FIGS. 8-10 is disposed downstream from disc filter subassembly 224 and includes granular activated carbon (GAC) designed to adsorb PFAS compounds from the substantially suspended-solids-free wastewater to produce PFAS-reduced wastewater. In this arrangement, the biological treatment module enhances performance of activated carbon bed 226 by reducing organic matter competition and extending GAC operational life. The wastewater treatment system achieves greater than about 90% removal efficiency for long-chain PFAS compounds including perfluorooctanoic acid (PFOA) and perfluorooctane sulfonic acid (PFOS).

The biologically active conduit preferably comprises aerobic biological chips containing aerobic dominant biologically active media disposed in aerobic stage of treatment 214 shown in FIG. 6, anoxic biological chips containing anoxic dominant biologically active media disposed in anoxic stage of treatment 216, and anaerobic biological chips containing anaerobic dominant biologically active media disposed in anaerobic stage of treatment 218.

The wastewater treatment systems for removing PFAS from wastewater may further comprise aerobic/anoxic treatment zone separator and anoxic/anaerobic treatment zone separator, implemented as mesh 212 shown in FIGS. 5A and 6, disposed between the respective treatment zones. The separators prevent displacement of biological chips 208 between treatment zones while allowing wastewater flow.

Activated carbon bed 226 is designed to remove at least one compound chosen from a group comprising perfluorooctanoic acid (PFOA), perfluorooctane sulfonic acid (PFOS), perfluorohexane sulfonic acid (PFHxS), perfluorononanoic acid (PFNA), and perfluorobutanesulfonic acid (PFBS).

The system further comprises a venturi system implemented as first venturi 200 or second venturi 202 shown in FIGS. 5A-5B, disposed at or near the aerobic treatment zone for introducing air to enhance aerobic bacterial activity and improve biotransformation of PFAS precursor compounds.

The biological treatment module reduces dissolved organic carbon (DOC) by at least 80% to minimize competition with PFAS compounds for GAC adsorption sites. The wastewater treatment systems for removing PFAS from wastewater further comprises UV disinfection module 228 shown in FIGS. 8-11, disposed downstream from activated carbon bed 226 for destroying any remaining PFAS compounds through photolysis.

The GAC has a bed depth of at least 3 feet and an empty bed contact time of at least about 10 minutes to optimize PFAS removal efficiency. The biological treatment module extends GAC operational life by at least about 25% compared to GAC systems without biological pre-treatment.

The wastewater treatment systems for removing PFAS from wastewater may further comprise a recirculation system implemented as first recirculation subassembly 174 or second recirculation assembly 195 shown in FIGS. 3 and 5A, for returning treated effluent to the biological treatment module to enhance PFAS precursor biotransformation through increased contact time. The wastewater treatment systems for removing PFAS from wastewater are preferably designed to treat wastewater containing PFAS concentrations ranging from about 10 ng/L to about 1000 μg/L.

The wastewater treatment systems for removing PFAS from wastewater may further comprise monitoring equipment for measuring PFAS concentrations before and after activated carbon bed 226 to verify removal efficiency. The biological treatment module includes bacterial communities chosen from a group comprising Pseudomonas species, Acidimicrobium species, and Gordonia species known to biotransform PFAS precursor compounds.

Disc filter subassembly 224 removes particles greater than about 10 microns to prevent GAC fouling and maintain optimal PFAS adsorption capacity. The wastewater treatment systems for removing PFAS from wastewater may further comprise a regeneration system for the GAC that includes thermal reactivation at temperatures between about 800° C. and about 900° C. to restore PFAS adsorption capacity.

The serpentine flow path shown in the biologically active conduits of FIGS. 4-6 provides a hydraulic retention time ranging between about 1 hour and about 8 hours in the biological treatment module to ensure adequate PFAS precursor biotransformation.

The wastewater treatment systems for removing PFAS from wastewater may further comprise a secondary carbon treating stage with virgin GAC disposed downstream from activated carbon bed 226 to achieve PFAS concentrations below about 10 ng/L in the PFAS-reduced wastewater.

In addition to system, the present teachings provide methods for removing PFAS from wastewater. One exemplar of such methods comprises biologically treating wastewater element, which involves biologically treating wastewater in a serpentine conduit having sequential aerobic, anoxic, and anaerobic treatment zones to reduce dissolved organic matter and biotransform PFAS precursor compounds.

The biologically treating wastewater element includes aerobically treating the wastewater with aerobic bacteria to complete biotransformation processes and reduce competing organic matter, anoxically treating the wastewater with anoxic bacteria to continue degradation of polyfluorinated intermediates and anaerobically treating the wastewater with anaerobic bacteria to initiate biotransformation of fluorinated precursor compounds. By way of example, biologically treating element utilizes the treatment zones and processes described in connection with aerobic stage of treatment 214, anoxic stage of treatment 216, and anaerobic stage of treatment 218 shown in FIG. 6.

The present methods for removing PFAS from wastewater comprises a filtering element, which includes filtering the biologically treated wastewater through disc filter subassembly 224 shown in FIGS. 8-10 to remove suspended solids and produce substantially suspended-solids-free wastewater, and an adsorbing element, which involves adsorbing PFAS compounds from the substantially suspended-solids-free wastewater using granular activated carbon (GAC) in activated carbon bed 226 to produce PFAS-reduced effluent.

Biological treating wastewater element enhances GAC adsorption efficiency by reducing dissolved organic matter that competes with PFAS for adsorption sites. The methods for removing PFAS from wastewater achieve removal of at least about 90% of long-chain PFAS compounds and at least about 70% of short-chain PFAS compounds from wastewater.

Biologically treating wastewater element includes maintaining different dissolved oxygen levels in each treatment zone, comprising maintaining dissolved oxygen levels above about 2 mg/L in aerobic stage of treatment 214, maintaining dissolved oxygen levels between about 0.2 and about 2.0 mg/L in anoxic stage of treatment 216, and maintaining dissolved oxygen levels below about 0.2 mg/L in anaerobic stage of treatment 218 shown in FIG. 6.

The biotransforming of PFAS precursor compounds, in biologically treating wastewater element, includes degrading fluorotelomer compounds selected from 6:2 fluorotelomer sulfonic acid, 8:2 fluorotelomer alcohol, and 6:2 fluorotelomer sulfonamide compounds.

The present method further comprises a monitoring element, which involves monitoring fluoride ion concentration in the biologically treated wastewater as an indicator of successful PFAS precursor biotransformation.

Biological treating wastewater element reduces dissolved organic carbon (DOC) concentration by at least about 80% to enhance subsequent GAC adsorption efficiency. The present methods for removing PFAS from wastewater may further comprise adjusting pH to between about 6.5 and about 8.5 during the biological treating to optimize bacterial activity for PFAS precursor biotransformation.

The adsorbing using GAC includes maintaining an empty bed contact time of at least about 10 minutes to achieve optimal PFAS removal efficiency.

The methods for removing PFAS from wastewater may further comprise a pre-oxidizing element, which includes pre-oxidizing wastewater with ozone prior to the biological treating to break down complex PFAS precursor compounds into more biodegradable intermediates. These methods for removing PFAS from wastewater may further include a recirculating element, which includes recirculating a portion of the biologically treated wastewater back to anaerobic stage of treatment 218 using the recirculation systems described in connection with FIGS. 3 and 5A to enhance PFAS precursor biotransformation through extended contact time.

Filtering element through disc filter subassembly 224 removes particles larger than 10 microns to prevent GAC fouling and maintain consistent PFAS adsorption performance. The methods for removing PFAS from wastewater may further comprise another monitoring element, which includes GAC breakthrough by measuring PFAS concentrations in the PFAS-reduced effluent and replacing GAC media when PFAS removal efficiency drops below about 85%.

The methods for removing PFAS from wastewater may include an inoculating element, which includes inoculating the biological treatment zones with bacterial cultures selected from Pseudomonas species, Gordonia species, and Acidimicrobium species to enhance PFAS precursor biotransformation. The biological treating wastewater may include providing electron donors selected from lactate, acetate, and methanol to support reductive biotransformation of PFAS precursor compounds in anaerobic stage of treatment 218.

The methods for removing PFAS from wastewater preferably further comprise a thermally regenerating element, which includes thermally regenerating spent GAC at temperatures between about 800° C. and about 900° C. to restore PFAS adsorption capacity and enable GAC reuse.

The methods for removing PFAS from wastewater may perform a treating element, which includes treating the PFAS-reduced effluent with ultraviolet light using UV disinfection module 228 shown in FIGS. 8-11 to photolytically destroy any remaining short-chain PFAS compounds. The methods for removing PFAS from wastewater treats wastewater containing initial PFAS concentrations between about 10 ng/L and about 1000 μg/L and produces effluent with PFAS concentrations below about 10 ng/L.

The methods for removing PFAS from wastewater may further comprise an analyzing element, which involves analyzing wastewater for PFAS compounds chosen from a group comprising perfluorooctanoic acid (PFOA), perfluorooctane sulfonic acid (PFOS), perfluorohexane sulfonic acid (PFHXS), perfluorononanoic acid (PFNA), perfluorodecanoic acid (PFDA), perfluorobutanesulfonic acid (PFBS), perfluorohexanoic acid (PFHXA), and perfluorobutanoic acid (PFBA) to verify comprehensive PFAS removal across compound classes.

In the following description, numerous specific details are set forth in order to provide a thorough understanding of the present teachings and arrangements. It will be apparent, however, to one skilled in the art that the present teachings and arrangements may be practiced without limitation to some or all of these specific details. In other instances, well-known process steps have not been described in detail in order to not unnecessarily obscure the present teachings and arrangements.

1. A wastewater treatment system comprising:
a biologically active conduit defining a single, confined serpentine flow path twisting from a top portion, through a middle portion, to a bottom portion, such that at or near said bottom portion, said single, confined serpentine flow path is populated with anaerobic dominant biologically active media to effectively create an anaerobic treatment zone, at or near said middle portion, said single, confined serpentine flow path is populated with anoxic dominant biologically active media to effectively create an anoxic treatment zone, and at or near said top portion, said single, confined serpentine flow path is populated with aerobic dominant biologically active media to effectively create an aerobic treatment zone, wherein said bottom portion has defined therein a bottom opening configured to receive influent wastewater, and following batch treatment simultaneously within said aerobic, said anoxic, and said anaerobic treatment zones of said single, confined serpentine flow path, dispense treated wastewater;
an aerobic/anoxic treatment zone separator disposed inside said biologically active conduit to serve as a physical boundary between said aerobic treatment zone and said anoxic treatment zone;
an anoxic/anaerobic treatment zone separator disposed inside said biologically active conduit to serve as a physical boundary between said anoxic treatment zone and said anaerobic treatment zone;
aerobic biological chips containing aerobic dominant biologically active media and disposed inside said aerobic treatment zone;
anoxic biological chips containing anoxic dominant biologically active media and disposed inside said anoxic treatment zone;
anaerobic biological chips containing anaerobic dominant biologically active media and disposed inside said anaerobic treatment zone, and
wherein said aerobic/anoxic treatment zone separator prevents displacement of said aerobic biological chips from said aerobic treatment zone into said anoxic treatment zone and said anoxic/anaerobic treatment zone separator prevents displacement of said anoxic biological chips from said anoxic treatment zone into said anaerobic treatment zone.

2. The wastewater treatment system of claim 1, further comprising a plurality of said biologically active conduits each having said confined serpentine flow paths terminating at said bottom opening, and wherein plurality of said biologically active conduits extend parallelly with respect to each other and are supported on a rack forming a module.

3. The wastewater treatment system of claim 2, wherein said module has a width ranging from about 7 feet to about 20 feet, a length ranging from about 5 feet to about 40 feet and a height ranging from about 8 feet to about 13 feet and said biologically active conduit has a diameter ranging from about 6 feet to about 12 feet.

4. The wastewater treatment system of claim 2, further comprising a recirculation subassembly including:
a recirculation inlet line designed to facilitate fluid communication of said treated wastewater from said bottom openings of said biologically active conduits to top inlets disposed at said top portion of plurality of said biologically active conduits;
one or more venturis disposed at or near a top portion of plurality of said biologically active conduits and designed to receive said treated wastewater from said recirculation inlet line and introducing air into said treated wastewater stream prior to said treated wastewater stream entering said top portion of said biologically active conduits; and
one or more recirculation manifolds disposed at or near a top portion of plurality of said biologically active conduits and downstream from one or more of said venturis, designed to be in fluid communication with said recirculation inlet line, and each of said recirculation manifolds having a plurality of recirculation manifold outlets designed to convey said treated wastewater, received from said recirculating line, to plurality of top inlets of plurality of said biologically active conduits.

5. The wastewater treatment system of claim 4, wherein said venturi is designed to draw air or oxygen to facilitate at least one type of aerobic treatment chosen from a group comprising digesting organic material present in wastewater, reducing chemical oxygen demand (“COD”), reducing biochemical oxygen demand (“BOD”), reducing ammonia to produce nitrite compounds, and reducing nitrite compounds to produce nitrate compounds.

6. The wastewater treatment system of claim 4, further comprising an influent line, which following batch treatment simultaneously within said aerobic, said anoxic, and said anaerobic treatment zones, provides said treated wastewater to said recirculation inlet line.

7. The wastewater treatment system of claim 1, further comprising an influent subassembly including:
an influent line designed for receiving wastewater from an equalization tank having stored therein wastewater for treatment; and
one or more influent manifold disposed at or near said bottom portion of plurality of said biologically active conduits and designed to be in fluid communication with said influent line, and each of said influent manifolds having a plurality of influent manifold outlets designed to convey said wastewater, received from said influent line, to plurality of said bottom openings of plurality of said biologically active conduits.

8. The wastewater treatment system of claim 1, further comprising an influent subassembly including:
a first isolation ball valve designed to stop flow of influent wastewater;
an influent automatic valve designed to automatically regulate flow of said influent wastewater;
a second isolation ball valve designed to stop flow of said influent wastewater after said influent automatic valve;
an influent grit solid screen designed to filter out solids present in said influent wastewater;
a third isolation ball valve designed to stop flow of said influent wastewater after said influent grit solid screen and into said biologically active conduit; and
wherein said first isolation ball valve and said second isolation ball valve are positioned to allow isolation of said influent automatic valve, and said second isolation ball valve and said third isolation ball valve are positioned to allow isolation of said influent grit solid screen for maintenance purposes.

9. The wastewater treatment system of claim 1, further comprising an overflow subassembly including:
one or more overflow manifolds disposed at or near said top portion of plurality of said biologically active conduits and each of said overflow manifolds having a plurality of overflow manifold outlets designed to receive, through a plurality of top outlets of said plurality of said biologically active conduits, excessive wastewater present inside one or more of said biologically active conduits;
an overflow line designed for collecting said excessive wastewater from plurality of said top outlets and dispensing said excessive wastewater to an equalization tank.

10. The wastewater treatment system of claim 1, further comprising an air/gas release passage, disposed at or near said anoxic treatment zone, for releasing air or gas collected inside said anoxic treatment zone to maintain an effective anoxic environment inside said anoxic treatment zone by reducing nitrate compound to nitrogen gas, wherein oxygen content in said anoxic environment is less than in said aerobic treatment zone.

11. The wastewater treatment system of claim 1, further comprising:
a first set of said biologically active conduits forming a first module;
a second set of said biologically active conduits forming a second module;
a first module effluent conduit in fluid communication with said first module and designed to convey treated wastewater from said first module to said second module or a recirculation inlet line, which recirculates said treated wastewater back to said first module;
a first module recirculation valve disposed on said recirculation inlet line and, in an open position, allows treated wastewater to flow from said first module, through said first module effluent conduit and said recirculation inlet line, back to said first module;
a first module post-treatment conduit in fluid communication with said second module;
a first automatic valve disposed on said first module post-treatment conduit and, in an open position, allows treated wastewater to advance from said first module to said second module; and
a discharge pump disposed at the intersection of said first module effluent conduit and said first module post-treatment conduit, such that in an open position of said first module recirculation valve and a closed position of said first automatic valve of said first module, said treated water flows back to said first module, and in an open position of said first automatic valve and a closed position of said first module recirculation valve, said treated water flows to said second module.

12. The wastewater treatment system of claim 11, further comprising:
a second module effluent conduit in fluid communication with said second module and designed to convey treated wastewater from said second module to a post-biological-treatment disc filter or a recirculation inlet line, which recirculates said treated wastewater back to said second module;
a second module recirculation valve disposed on said recirculation inlet line and, in an open position, allows treated wastewater to flow from said second module, said second module effluent conduit and said second module recirculation inlet line, back to said second module;
a second module post-treatment conduit in fluid communication with said second module;
a second automatic valve disposed on said second module post-treatment conduit and, in an open position, allows treated wastewater to advance from said second module to a disc filter; and
a discharge pump disposed at the intersection of said first module effluent conduit and said first module post-treatment conduit, such that in an open position of said second module recirculation valve and a closed position of said second automatic valve, said treated water flows back to said second module, and in an open position of said second automatic valve and a closed position of said second module recirculation valve, said treated water flows to said disc filter subassembly.

13. The wastewater treatment system of claim 12, wherein said second module is disposed downstream from said first module, wherein each of said module includes plurality of said parallelly extending biologically active conduits, one or more of said aerobic/anoxic treatment zone separators, one or more of said anoxic/anaerobic treatment zone separators, said aerobic biological chips, said anoxic biological chips, and said anaerobic biological chips, and wherein said first module is designed to carry out a first type of wastewater treatment and said second module is designed to a second type of wastewater treatment, which is different from said first type of wastewater treatment.

14. The wastewater treatment system of claim 12, wherein said first module, during an operational state, removes organic compounds from wastewater present inside first module and said second module, during said operational state, removes nutrients from wastewater present inside second module.

15. The wastewater treatment system of claim 1, further comprising:
one or more of said biologically active conduits;
a solids-separator subsystem disposed upstream from one or more of said biologically active conduits and designed to separate solids from said wastewater;
an equalization tank disposed downstream from said solids-separator subsystem and designed to hold said wastewater received from said solids-separator subsystem;
a level sensor designed to detect wastewater level present inside said equalization tank; and
a pump communicatively coupled to said level sensor such that when said level sensor, in an operative state, detects a predetermined wastewater level value inside said equalization tank, said level sensor conveys a signal that is received by said pump to pump said wastewater from said equalization tank to one or more of said biologically active conduits.

16. The wastewater treatment system of claim 15, further comprising a domestic wastewater line designed to deliver said wastewater from a domestic source to a septic tank, which serves as said solids-separator subsystem, and/or a commercial/industrial wastewater line designed to deliver said wastewater from a commercial/industrial source to said solids-separator subsystem.

17. The wastewater treatment system of claim 1, wherein each of said aerobic/anoxic treatment zone separator and said anoxic/anaerobic treatment zone separator is composed of a mesh, which has defined therein openings that prevent relatively larger aerobic biological chips, anoxic biological chips, and anaerobic biological chips from passing through and allow said wastewater and said treated wastewater to pass through.

18. The wastewater treatment system of claim 1, further comprising a disc filter subassembly disposed downstream from said anaerobic treatment zone of said biologically active conduit and designed to filter out suspended solids from said wastewater present inside said disc filter subassembly and produce substantially suspended-solids-free wastewater.

19. The wastewater treatment system of claim 18, further comprising carbon treating subassembly disposed downstream from said disc filter subassembly and designed to polish using a carbon source said substantially suspended-solids-free wastewater and produce carbon-treated wastewater.

20. The wastewater treatment system of claim 19, further comprising carbon treating subassembly designed to remove any one compound chosen from a group comprising per- and polyfluoroalkyl substances (“PFAS”), organic and inorganic compounds from said wastewater present inside said carbon treating subassembly to produce carbon-treated wastewater.

21. The wastewater treatment system of claim 20, further comprising an ultraviolet treatment subsystem disposed downstream from said carbon treating subassembly and designed to treat said carbon-treated wastewater with light in UV spectrum.

22. The wastewater treatment system of claim 1, further comprising a disinfecting subsystem disposed downstream from said anaerobic treatment zone of said biologically active conduit for treating wastewater present inside said disinfecting subsystem with a disinfectant.

23-98. (canceled)
